(19) United States
(12) Patent Application Publication
(10) Pub. No.: US 2009/0265650 A1
(43) Pub. Date: Oct. 22, 2009

(54) Efficient Information Transfer Systems

(76) Inventor: Christopher A. Canovai, Burlington, NC (US)

Correspondence Address: Stoneman Volk Patent Group, 3770 NORTH 7TH STREET, Suite 100, PHOENIX, AZ, 85014, US

(21) Appl. No.: 12/425,372

(22) Filed: Apr. 16, 2009

Related U.S. Application Data
(60) Provisional application No. 61/046,373, filed on Apr. 18, 2008.
(60) Provisional application No. 61/107,325, filed on Oct. 21, 2008.

(51) Int. Cl. G06F 3/048; G06F 3/00; G06F 17/30

(52) U.S. Cl. 715/769; 715/760; 707/102; 707/E17.005

(57) ABSTRACT

This invention relates to providing a system for improved user productivity and administrative management capability enabling control of software application functionality. Productivity is enabled with a single drag-and-drop operation for moving data in email attachments to web-enabled databases. In commercial work environments, where multiple computer software applications must collaborate with assistance of a user, it is desirable to have an environment facilitating efficiency of user input for accomplishing tasks, particularly in efficient transferring, particularly using a drag-and-drop point/select/command device, particularly using only one user motion for each transfer, of multiple data files from an email application into a browser-accessible database.

### CROSS-REFERENCE TO RELATED APPLICATION

The present application is related to and claims priority from prior provisional application Ser. No. 61/046,373, filed Apr. 18, 2008, entitled “FILE TRANSFER SYSTEMS”, and is related to and claims priority from prior provisional application Ser. No. 61/107,325, filed Oct. 21, 2008, entitled “EFFICIENT INFORMATION TRANSFER SYSTEMS”, the contents of both of which are incorporated herein by this reference and are not admitted to be prior art with respect to the present invention by the mention in this cross-reference section.

### BACKGROUND

This invention relates to efficient information transfer systems, particularly providing a system for improved user productivity and administrative management capability enabling control of software application functionality. In commercial work environments, where multiple computer software applications must collaborate with assistance of a user, it is desirable to have an environment facilitating efficiency of user input for accomplishing tasks. Enabling administrative management of software application functionality creates a focused work environment keeping software applications (such as Internet web browsers) from being used for purposes other than commercial purposes.

More particularly, this invention relates to enhancing productivity (and overcoming productivity problems) by tightly integrating graphical user interfaces of multiple software applications together.

### OBJECTS AND FEATURES OF THE INVENTION

A primary object and feature of the present invention is to provide a system overcoming the above-mentioned problems.

It is a further object and feature of the present invention to provide such a system enhancing data transfer between software applications such as email and web-enabled databases.

It is yet a further object and feature of the present invention to provide such a system that tightly integrates graphical user interfaces of multiple commercial off the shelf (“COTS”) software applications, such as email and database clients.

It is another object and feature of the present invention to provide software architecture capable of enhancing productivity by providing transfer of email attachments for input a database by a simple drag-and-drop operation.

It is yet another object and feature of the present invention to provide software architecture capable of enhancing productivity and focusing the work environment.

It is yet a further object and feature of the present invention to enhance administrative control of applications.

It is yet another object and feature of the present invention to facilitate management of a focused and task-oriented work environments.

It is another object and feature of the present invention to provide administrative control to allow enablement of only that functionality needed for the required task.

It is another object and feature of the present invention to provide close proximity of all graphical elements, thus permitting efficient user interaction with all integrated software applications.

It is another object and feature of the present invention to provide a drag-and-drop moving step to permit the user to perform such moving step with exactly one continuous motion of the point/select/command device.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system, relating to, using at least one GUI display and at least one point/select/command device, transferring useful information, associated with user-selected data associated with at least one data icon, between at least one first software application displaying in at least one first pane and at least one second software application displaying in at least one second pane, comprising: first software application computing means for providing at least one first set of software operations displayable-in the at least one first pane; second software application computing means for providing at least one second set of software operations displayable-in the at least one second pane; icon selector computing means for selecting, using the point/select/command device, within the at least one first display pane, the at least one data icon; icon mover computing means for moving, using the point/select/command device, the at least one data icon from the at least one first display pane to the at least one second display pane; and icon releaser computing means for releasing, using the point/select/command device, within the at least one second display pane, the at least one data icon; wherein such icon releaser computing means comprises information classifier computing means for classifying the useful information to categorize any metadata to provide metadata classification information; and information transfer computing means for transferring the useful information and any associated metadata classification information to the second software application.

Moreover, it provides such a system wherein such first software application computing means comprises at least one email-client software application. Additionally, it provides such a system wherein such second software application computing means comprises at least one web-browser software application. Also, it provides such a system wherein such at least one web-browser software application displays within the at least one pane of the at least one email-client software application. In addition, it provides such a system wherein: such at least one web-browser software application comprises at least one database client software application; and such information transfer computing means transfers the useful information and such any associated at least one metadata classification information to such at least one database client software application. And, it provides such a system wherein such any associated at least one metadata classification information comprises at least one user-selected data extension file type.

Further, it provides such a system wherein such information classifier computing means comprises file type identifier computing means for identifying at least one user-selected data extension file type. Even further, it provides such a system, further comprising user limiter computing means for administratively limiting user access to such at least one web-browser software application. Moreover, it provides such a system, wherein such user limiter computing means comprises text field limiter computing means for limiting at least one edit property of at least one editable text field.

In accordance with another preferred embodiment hereof, this invention provides a program, relating to, using at least one GUI display and at least one point/select/command device, transferring useful information, associated with user-selected data associated with at least one data icon, between at least one first software application displaying in at least one first pane and at least one second software application displaying in at least one second pane, comprising the steps of: providing at least one first set of software operations displayable in the at least one first pane; providing at least one second set of software operations displayable in the at least one second pane; selecting, using the point/select/command device, within the at least one first display pane, the at least one data icon; moving, using the point/select/command device, the at least one data icon from the at least one first display pane to the at least one second display pane; and releasing, using the point/select/command device, within the at least one second display pane, the at least one data icon; classifying the useful information to categorize any metadata to provide metadata classification information; and transferring the useful information and any associated metadata classification information to the second software application.

Additionally, it provides such a system wherein such first set of software operations comprises at least one email-client software application. Also, it provides such a system wherein such second set of software operations comprises at least one web-browser software application. In addition, it provides such a system wherein such at least one web-browser software application displays within the at least one pane of the at least one email-client software application. And, it provides such a system wherein: such at least one web-browser software application comprises at least one database client software application; and the useful information and such any associated at least one metadata classification information is transferred to such at least one database client software application. Further, it provides such a system wherein such at least one metadata classification information comprises at least one user-selected data extension file type.

Even further, it provides such a system wherein such classifying the useful information comprises identifying at least one user-selected data extension file type. Moreover, it provides such a system, further comprising administratively limiting user access to such at least one web-browser software application. Additionally, it provides such a system, wherein such administratively limiting user access comprises limiting at least one edit property of at least one editable text field.

In accordance with another preferred embodiment hereof, this invention provides a system, relating to, using at least one GUI display and at least one point/select/command device, transferring information, associated with user-selected data associated with at least one data icon, between at least one first software application displaying in at least one first pane and at least one second software application displaying in at least one second pane, comprising: at least one first software application processor adapted to provide at least one first set of software operations displayable-in the at least one first pane; at least one second software application processor adapted to provide at least one second set of software operations displayable-in the at least one second pane; at least one icon selector processor adapted to select, using the point/select/command device, within the at least one first display pane, the at least one data icon; at least one icon mover processor adapted to move, using the point/select/command device, the at least one data icon from the at least one first display pane to the at least one second display pane; and at least one icon releaser processor adapted to release, using the point/select/command device, within the at least one second display pane, the at least one data icon; wherein such at least one icon releaser processor comprises at least one information classifier processor adapted to classify the information to categorize any metadata; and at least one information transfer processor adapted to transfer the information and any associated at least one user-selected data extension file type to the at least one second software application processor.

Also, it provides such a system wherein such first software application processor comprises at least one email-client software application processor. In addition, it provides such a system wherein such second software application processor comprises at least one web-browser software application processor. And, it provides such a system wherein such at least one web-browser software application processor displays within the at least one pane of the at least one email-client software application processor. Further, it provides such a system wherein: such at least one web-browser software application processor comprises at least one database client software application processor; and such information transfer processor transfers the useful information and such any associated at least one metadata classification information to such at least one database client software application processor. Even further, it provides such a system wherein such any associated at least one metadata classification information comprises at least one user-selected data extension file type.

Moreover, it provides such a system wherein such information classifier processor comprises at least one file type identifier processor that identifies at least one user-selected data extension file type. Additionally, it provides such a system, further comprising at least one user limiter processor that administratively limits user access to such at least one web-browser software application. Also, it provides such a system, wherein such user limiter processor comprises text field limiter processor that limits at least one edit property of at least one editable text field.

In accordance with another preferred embodiment hereof, this invention provides a digital storage means containing computer readable indicia representing a computer program relating to, using at least one GUI display and at least one point/select/command device, transferring information, associated with user-selected data associated with at least one data icon, between at least one first software application displaying in at least one first pane and at least one second software application displaying in at least one second pane, such program comprising the steps of: providing at least one first set of software operations displayable in the at least one first pane; providing at least one second set of software operations displayable in the at least one second pane; selecting, using the point/select/command device, within the at least one first display pane, the at least one data icon; moving, using the point/select/command device, the at least one data icon from the at least one first display pane to the at least one second display pane; releasing, using the point/select/command device, within the at least one second display pane, the at least one data icon; classifying the information to categorize any metadata; identifying at least one user-selected data extension file type; transferring the information and any associated at least one user-selected data extension file type to the at least one second software application.

In addition, it provides such a system wherein such first set of software operations comprises at least one email-client software application. Also, it provides such a system wherein such second set of software operations comprises at least one web-browser software application. Further, it provides such a system wherein such at least one web-browser software application displays within the at least one pane of the at least one email-client software application. Even further, it provides such a system wherein: such at least one web-browser software application comprises at least one database client software application; and the useful information and such any associated at least one metadata classification information is transferred to such at least one database client software application. Moreover, it provides such a system wherein such at least one metadata classification information comprises at least one user-selected data extension file type. Additionally, it provides such a system wherein such classifying the useful information comprises identifying at least one user-selected data extension file type. Also, it provides such a system further comprising administratively limiting user access to such at least one web-browser software application. In addition, it provides such a system wherein such administratively limiting user access comprises limiting at least one edit property of at least one editable text field.

In accordance with another preferred embodiment hereof, this invention provides a method, relating to providing labor-saving multiple data transfers into at least one database application from another application, comprising the steps of: providing at least one data transfer software application adapted to assist labor-saving information transfer into at least one database application; monetizing use of such at least one data transfer software application by at least one user seeking such labor-saving information transfer; wherein such at least one data transfer software application comprises at least the steps of providing at least one first set of software operations displayable in at least one first pane of at least one GUI, providing at least one second set of software operations displayable in at least one second pane of the at least one GUI, wherein such at least one second set of software operations comprises the at least one database application, selecting, using at least one point/select/command device, within the at least one first display pane, at least one data icon, moving, using the at least one point/select/command device, the at least one data icon from the at least one first display pane to the at least one second display pane, wherein such moving step is enabled to permit at least one user to perform such moving step with exactly one continuous motion of the at least one point/select/command device (“drag”), releasing, using the point/select/command device, within the at least one second display pane, the at least one data icon, classifying the useful information to categorize any metadata to provide metadata classification information, and transferring the useful information and any associated metadata classification information to the at least one database application; wherein the at least one user is enabled to make labor-saving multiple data transfers into the at least one database application.

Further, it provides such a method wherein such at least one first set of software operations comprises at least one email software application. Further, it provides such a method wherein such at least one second pane comprises at least one browser interface. Even further, it provides such a method further comprising the step(s) of: providing, in such at least one database application, sufficient administrative control of such at least one user to enhance labor-saving monetizing of such multiple data transfers; wherein such labor-saving monetizing comprises enabling better performance. Even further, it provides such a method wherein such labor-saving monetizing comprises better performing of compliance.

Even further, it provides such a method wherein such labor-saving monetizing comprises better performing of compliance in at least the area of risk management. Even further, it provides such a method wherein such labor-saving monetizing comprises better performing of compliance in at least the area of time management.

In accordance with another preferred embodiment hereof, this invention provides each and every novel feature, element, combination, step and/or method disclosed or suggested by this patent application.

### BRIEF DESCRIPTION OF THE DRAWINGS

FIG. 1A shows, diagrammatically, a computer used for commercial or personal computing applications, according to a preferred embodiment of this invention.

FIG. 1B shows, diagrammatically, memory region allocation created by an operating system of system memory, according to a preferred embodiment of this invention.

FIG. 2A shows, diagrammatically, an application data transfer system, interaction of user with graphical user interface, add-in host end user application with file data read access, and file data write access of file initialization data, according to a preferred embodiment of this invention.

FIG. 2B shows, diagrammatically, initialization data for add-in host end user application, according to a preferred embodiment of this invention.

FIG. 3 shows, diagrammatically, computers connected in a data network allowing collaboration of distributed end user application accomplishing a common function, according to a preferred embodiment of this invention.

FIG. 4 shows, diagrammatically, window frame layout of graphical user interface used by end user application to display data on display, according to a preferred embodiment of this invention.

FIG. 5 shows, diagrammatically, categories of initialization data used by add-in host end user application, according to a preferred embodiment of this invention.

FIG. 6 shows, diagrammatically, initialization data used by add-in host end user application for authentication, according to a preferred embodiment of this invention.

FIG. 7 shows, diagrammatically, initialization data of explorer ID used to configure web browser and filesystem panes within window frame of OUTLOOK® Explorer, according to a preferred embodiment of this invention.

FIG. 8 shows, diagrammatically, initialization data of inspector ID used to configure web browser and filesystem panes with OUTLOOK® Inspector, according to a preferred embodiment of this invention.

FIG. 9 shows, diagrammatically, initialization data of URL ID that configures web browser address combo box with predefined URLs and filesystem address combo box with filesystem paths, according to a preferred embodiment of this invention.

FIG. 10 shows an illustration, of a layout of panes for OUTLOOK® Explorer window frame that includes web-browser and filesystem explorer add-in panes, according to a preferred embodiment of this invention.

FIG. 11 shows an illustration, of a layout of panes for OUTLOOK® Inspector window frame that includes web-browser and hidden filesystem explorer add-in panes, according to a preferred embodiment of this invention.

FIG. 12 shows an illustration, of a layout of panes for OUTLOOK® Inspector window frame that includes web-browser add-in pane and showing preferences dialog, according to a preferred embodiment of this invention.

FIG. 13 shows an illustration, of preferences dialog with tabs that allows access to display layout, Universal Resource Locator (“URL”) URL locations, and administrative preference attributes, according to a preferred embodiment of this invention.

FIG. 14 shows an illustration, of preferences dialog that allows defining of web URLs and file addresses to initialize web and filesystem add-in address combo boxes, according to a preferred embodiment of this invention.

FIG. 15 shows an illustration, of preferences dialog that allows setting of add-in host lock, administrator username, and password, according to a preferred embodiment of this invention.

FIG. 16 shows, diagrammatically, OUTLOOK® Explorer window frame and menu items to access preference configuration, according to a preferred embodiment of this invention.

FIG. 17 shows, diagrammatically, OUTLOOK® Explorer window frame with web-browser URL drop-down combo box, according to a preferred embodiment of this invention.

FIG. 18 shows, diagrammatically, OUTLOOK® Explorer window frame with filesystem address drop-down combo box, according to a preferred embodiment of this invention.

FIG. 19 shows, diagrammatically, OUTLOOK® email EUA add-in in-box transferring data to web-browser database client, according to a preferred embodiment of this invention.

FIG. 20 shows, diagrammatically, position enumeration states specifying layout position of pane, preferably three-dimensionally or preferably two-dimensionally, in window frame layout, according to a preferred embodiment of this invention.

FIG. 21 shows an overall schematic illustration, productivity method licensor enabling increased productivity of data transfer between email and web-enabled database, according to a preferred embodiment of the present invention.

FIG. 22 shows a schematic illustration, of a business method for enabling productivity method licensor, compliance requirements, and risk management, according to the preferred embodiment of FIG. 21.

FIG. 23 shows a functional illustration, of a preferred implementation of a preferred business method for enabling productivity method licensor, compliance requirements, and risk management, according to the preferred embodiment of FIG. 22.

FIG. 24 shows a schematic illustration of a typical processor configuration for an implementation of the method relating to productivity method licensor, compliance requirements, and risk management, according to the preferred embodiment of FIG. 22.

### DETAILED DESCRIPTION OF THE BEST MODES AND PREFERRED EMBODIMENTS OF THE INVENTION

Commercial users of computer software applications have many tasks requiring data transfer from email file attachments to database applications with web clients that use the file attachments as input. Tightly integrating graphical user interfaces (“GUI”) of multiple software applications creates an environment where minimal input is required by a user to accomplish desired tasks. Close proximity (e.g., no graphical elements are hidden from view by other elements) of all graphical elements permits efficient user interaction with all integrated software applications.

Commercial enterprises facilitate software programs for performance of specific tasks by employees and customers to accomplish commercial goals for a benefit to an organization. In certain commercial situations, it is desirable to have software applications that are preferably focused on a specific task and preferably cannot be diverted to other undesirable tasks. Integrating GUIs of multiple software applications preferably provides a framework by which administrative configuration capabilities over a software application features are facilitated.

Improvement of productivity and administrative control preferably are facilitated by preferably integrating GUIs of multiple software applications into a graphical display window frame of preferably multiple panes with a layout manager. A configuration of GUIs preferably tightly integrated into the same graphical window frame requires less manipulation by a user to enter input events. The tight integration of the email and web-enabled database applications GUIs preferably allows a single drag-and-drop operation to transfer data from email and input the data to the database.

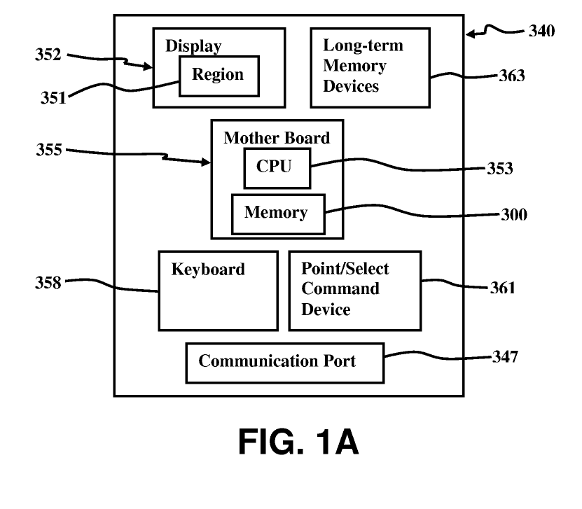

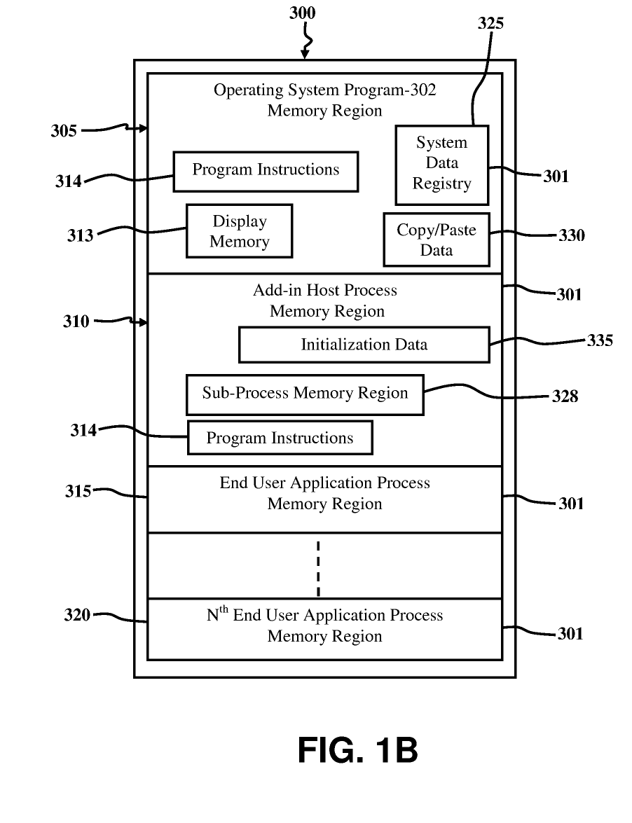

FIG. 1A shows diagrammatically general-purpose computer 340 used for commercial or personal computing applications. Computer 340 preferably includes at least one bi-directional data communication port 347, at least one display 352, at least one motherboard 355, at least one system memory 300, at least one keyboard 358, at least one long-term memory device 363, and at least one point/select command device 361, as shown.

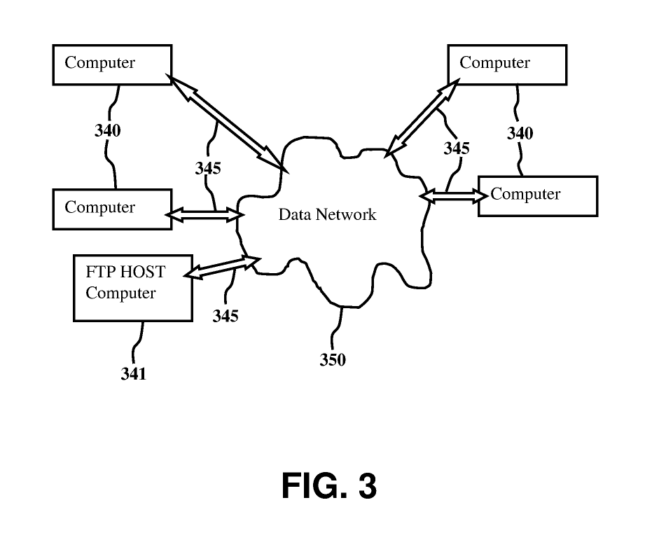

Computer 340 preferably communicates using bi-directional data communication port 347 with preferably at least one other computer 340. Computer 340 preferably connects via bi-directional data communication connection 345 to data network 350, as shown (see FIG. 3).

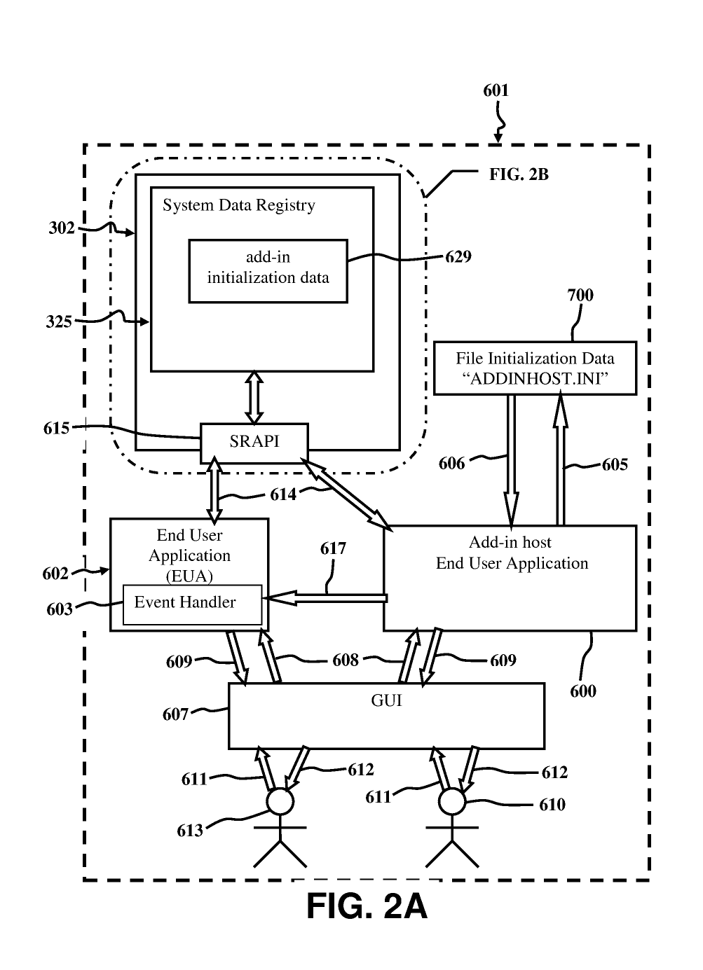

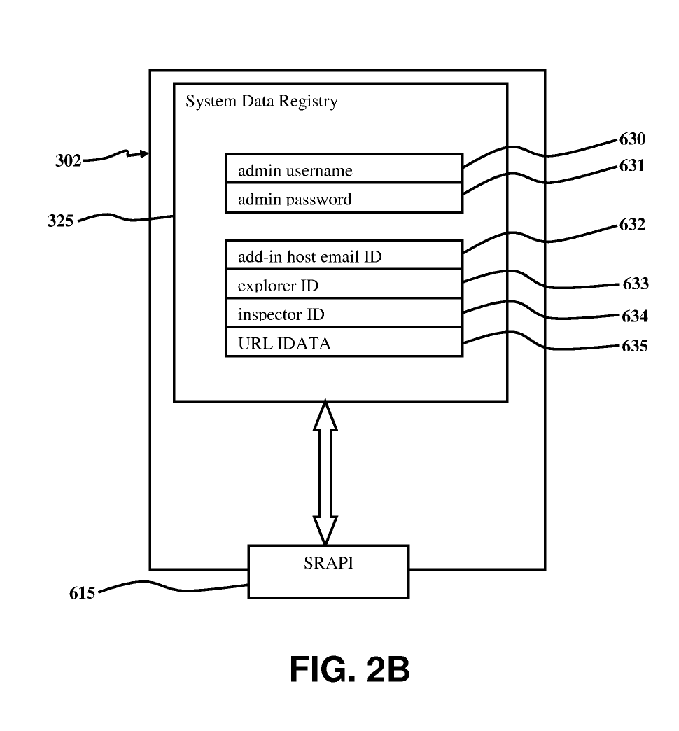

Computer 340 preferably displays visual graphical images in at least one display region 351 of display 352. Motherboard 355 facilitates execution of end user application (“EUA”), EUA 602 (see FIG. 2A). System memory 300 is preferably comprised of short-term memory. Keyboard 358, or, alternately preferable, any device facilitating symbolic input, includes alphanumeric keys used to input alphanumeric character data to EUA 602. Point/select command device 361 preferably comprises at least one device type facilitating data and command event input, preferably capable of drag-and-drop abilities, preferably two-dimensional, preferably at least one mouse. Upon reading the teachings of this specification, those of ordinary skill in the art will now understand that, under appropriate circumstances, considering such issues as technology advances, purpose of the application, user then preferences, etc., other point/select command devices for the EUA, such as touch screen devices, voice recognition devices, vision recognition devices, three-dimensional devices, etc., may suffice.

Long-term memory device 363 preferably comprises any memory device type that retains its state information after power has been removed, preferably a read/write disk drive or, alternately preferable, electrically programmable semi-conductor memory.

FIG. 1B shows diagrammatically memory region allocation 301 created by an operating system program 302 of system memory 300. System memory 300 preferably comprises at least one memory region 305, at least one process memory region 310 of add-in host EUA 600, at least one process memory region 315, and at least one nth process memory region 320, as shown.

Memory region 305 preferably supports functionality of operating system program 302. Process memory region 310 of add-in host EUA 600 preferably supports functionality of add-in host end user application (“add-in host EUA”), add-in host EUA 600 (see FIG. 2A). Initialization data 335 of add-in host EUA 600 preferably comprises state data information (which controls and configures operational functionality) of add-in host EUA 600. Process memory region 310 of add-in host EUA 600 preferably comprises at least one sub-process memory region 328. Sub-process memory region 328 preferably provides a program execution environment for EUA 602. Alternately, process memory region 315 preferably provides a program execution environment for EUA 602.

Operating system program 302 preferably allocates memory region allocation 301 of system memory 300. System memory 300 preferably comprises different types of memory, preferably including short-term memory (volatile) and long-term memory (non-volatile). Short-term memory loses its current state when power to system memory 300 is discontinued.

Memory region 305 of operating system program 302 preferably comprises at least one system data registry 325, at least one copy/paste variable data memory buffer 330, and at least one display memory 313, as shown. System data registry 325 preferably provides long-term storage of state data for operating system program 302 and state data for add-in host EUA 600 (see FIG. 2A). Copy/paste variable data memory buffer 330 preferably provides temporary data storage for data to be transported via copy then paste inputs between at least two EUA's 602. Display memory 313 preferably comprises state data accessed by a graphics pipeline to render preferably at-least-two-dimensional graphic images onto display 352 of computer 340.

FIG. 2A shows diagrammatically application data transfer system 601, interaction of user 613 with GUI 607, add-in host EUA 600 (with file data read access 606, and file data write access 605) of file initialization data (“file ID”), file ID 700, of add-in EUA 600. Application data transfer system 601 preferably comprises at least one add-in host EUA 600, at least one EUA 602, at least one file data write access 605, at least one file data read access 606, at least one file ID 700, at least one GUI 607, at least one operating system program 302, at least one system data registry 325, at least one digital data input events 608, at least one output display data 609, at least one administrator 610, at least one user inputs 611, at least one graphical display information 612, at least one user 613, at least one registry access function 614, at least one system registry application programming interface (“SRAPI”), SRAPI 615, at least one data transfer event 617, and at least one add-in initialization data 629 providing productivity enhancements with integrated administrative functionality controls, as shown.

A foundational implementation capability and integration of add-in host EUA 600 (with other EUA 600 GUIs) are preferably facilitated with Add-in Express™ for OUTLOOK® Express. Add-in Express™ (available at Internet URL address www.add-in-express.com) is a family of rapid application development (“RAD”) tools for customizing the GUI of OUTLOOK® Explorer or OUTLOOK® Inspector by adding additional panes 110 into window frame layout 101. These panes 110 are regions used by EUA 600 as its display pane 110. Upon reading the teachings of this specification, those of ordinary skill in the art will now understand that, under appropriate circumstances, considering such issues as technology advances, purpose of the application, new tool development, then user preferences, etc., other tool suites for supporting software RAD, such as new integrated development environments, new software foundation libraries, new GUI libraries, etc., may suffice.

Web browser generally refers to any EUA 602 that allows user 613 to navigate to a URL and then it displays the web page, such as Internet Explorer® by Microsoft Corporation. Filesystem explorer generally refers to any EUA 602 that allows user 613 to navigate through a file system and display the contents of a directory tree, such as Windows® Explorer by Microsoft Corporation. Database client generally refers to any EUA 602 that accesses a database by query, read, or write, such as INTELLIDOX® by Forefront Technologies, Inc. of Burlington, N.C.

Add-in host EUA 600 preferably comprises OUTLOOK® Explorer or OUTLOOK® Inspector, alternately preferably, all software applications that utilize GUI 607.

EUA 602 preferably comprises at least one software application that utilizes GUI 607 (at least embodying herein second software application computing means for providing at least one second set of software operations displayable-in the at least one second pane) and at least one event handler 603. Event handler 603 of EUA 602 is a sequence of code that processes data transfer event 617 resulting from a drag-and-drop event focused on EUA 602. Alternately, EUA 602 preferably comprises at least one event handler 603, at least one Internet web browser, at least one filesystem explorer, and/or at least one local or remote database client. Upon reading the teachings of this specification, those of ordinary skill in the art will now understand that, under appropriate circumstances, considering such issues as technology advances, purpose of the application, new software development, user then preferences, etc., other software applications for the EUA, such as web services, information filters, search engines, stand-alone applications, etc., may suffice.

Add-in host EUA 600, on installation, preferably initializes system data registry 325 via SRAPI 615 creating add-in initialization data 629 for add-in host EUA 600 startup processing. Operating system program 302 preferably provides SRAPI 615 for add-in host EUA 600 and EUA 602 to create, read and write state data with registry access function 614.

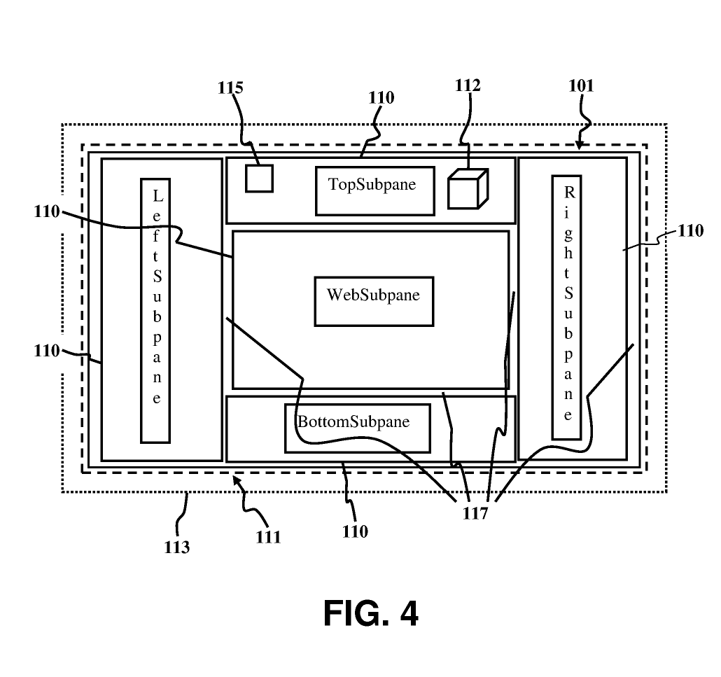

User 613 and administrator 610 preferably provide inputs 611 to GUI 607 invoking functionality and services provided by add-in host EUA 600. Add-in host EUA 600 preferably receives input via digital input events 608. Add-in host EUA 600 preferably sends output display data 609 to GUI 607 (at least embodying herein first software application computing means for providing at least one first set of software operations displayable-in the at least one first pane). GUI 607 preferably renders output display data 609 in at least one window frame layout 101 (see FIG. 4). Digital data input events 608 preferably comprise input of at least one keyboard 358 (see FIG. 1A) or at least one point/select command device 361.

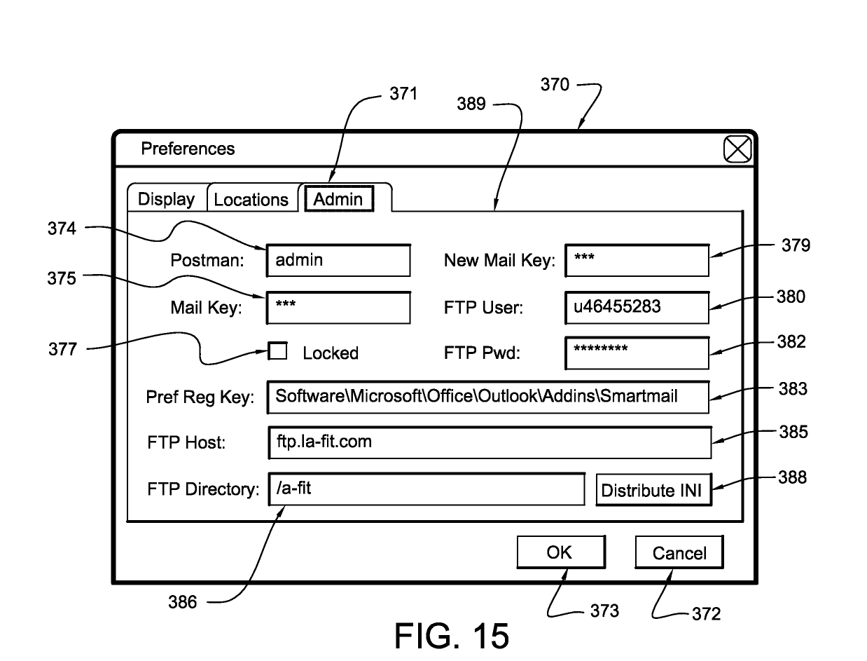

Add-in host EUA 600 preferably invokes file data read access 606 obtaining a copy of file ID 700. Add-in host EUA 600 preferably enables functionality of at least one EUA 602 based on predefined states of preferably at least one file ID 700. File ID 700, preferably contained in a file, stores in preferably at least one long-term memory device 363 (see FIG. 1A). Data preferably is read with file data read access 606 from a file containing file ID 700. Application data transfer system 601 preferably places file ID 700 in at least one initialization data 335 (see FIG. 1B) of add-in host EUA 600. File ID 700 and initialization data 335 (see FIG. 1B) of add-in host EUA 600 are preferably stored in a data record structure as shown in diagrams of FIGS. 15, 16, 17, 18, and 19.

Alternately, during installation of add-in host EUA 600, add-in host EUA 600 preferably invokes file data read access 606 obtaining a copy of file ID 700. Add-in host EUA 600 invokes at least one registry access function 614 copying file ID 700 to add-in initialization data 629 for long-term storage.

FIG. 2B shows diagrammatically initialization data 629 contained in system data registry 325 used by add-in host end user application. System data registry 325 preferably comprises at least one admin username 630, and at least one admin password 631, or, alternately preferably, at least one add-in host email ID 632, at least one explorer ID 633, at least one inspector ID 634, and at least one URL IDATA 635, as shown.

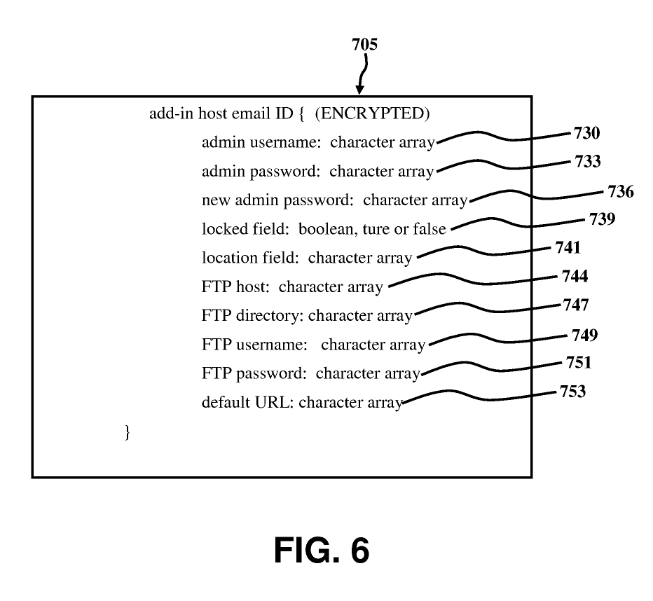

Startup authentication of add-in host EUA 600 (see FIG. 2A) preferably occurs by a match when comparing admin username 730 (see FIG. 6) and admin password 733 in initialization data 335 (see FIG. 1B) of add-in host EUA 600 to values of admin username 630 and admin password 631 respectively in system data registry 325. Add-in host EUA 600 preferably accesses admin username 630 and admin password 631 fields via SRAPI 615. Add-in host EUA 600 preferably compares admin username 730 and admin password 733 to values in fields of admin username 630 and admin password 631, respectively. If the compared fields match, then add-in host EUA 600 is authenticated and not in lock down mode. If the compared fields do not match, then add-in host EUA 600 is not authenticated and is in lock down mode.

Alternately preferably, startup authentication of add-in host EUA 600 (see FIG. 2A) preferably occurs by a match when comparing admin username 730 (see FIG. 6) and admin password 733 in initialization data 335 (see FIG. 1B) of add-in host EUA 600 to values of admin username 730 and admin password 733, of add-in host email ID 632 of system data registry 325, respectively. Admin username 730 (see FIG. 6) and admin password 733 in initialization data 335 of add-in host EUA 600 are input via processing of preferences dialog 370 (see FIG. 15). Add-in host EUA 600 preferably accesses admin username 630 and admin password 631 fields via SRAPI 615. Add-in host EUA 600 preferably compares admin username 730 and admin password 733 in initialization data 335 of add-in host EUA 600 to values of admin username 630 and admin password 631 fields, respectively. If the compared fields match, then administrator 610 of add-in host EUA 600 is authenticated and add-in host EUA 600 is not in lock down mode. If the compared fields do not match, then administrator 610 of add-in host EUA 600 is not authenticated and is in lock down mode. Upon reading the teachings of this specification, those of ordinary skill in the art will now understand that, under appropriate circumstances, considering such issues as technology advances, purpose of the application, user then preferences, etc., other means for administrator authentication, such as, retinal scan, finger print scan, hand print scan, facial image recognition, voice recognition, etc., may suffice.

FIG. 3 shows diagrammatically computers 340 preferably connected in data network 350 preferably allowing collaboration of distributed end user application 602 accomplishing a common function. Data network 350 preferably comprises at least one bi-directional data communication connection 345, at least one computer 340, and at least one FTP server 341, as shown.

Computers 340 preferably communicate in data network 350 with bi-directional data communication connection 345. Data network 350 preferably facilitates collaboration of at least one distributed add-in host EUA 600 (see FIG. 2A) and/or at least one EUA 602 preferably accomplishing goals of user 613. Bi-directional data communication connection 345 preferably provides connection from bi-directional data communication port 347 of computer 340 with data network 350. Data network 350 preferably comprises at least one Internet and/or preferably at least one Intranet. Upon reading the teachings of this specification, those of ordinary skill in the art will now understand that, under appropriate circumstances, considering such issues as technology advances with new materials, methods of communication, user then preferences, etc., other data network systems, such as, fiber optics, radio frequency, modulated laser beams, microwave, electro-magnetic force, etc., may suffice.

FIG. 4 shows diagrammatically window frame layout 101 of GUI 607 used by end user application 602 to display data on display 352 (see FIG. 1A). Display region 113 preferably comprises at least one window frame layout 101, at least one pane 110, at least one border region 117, at least one button 115, at least one widget 112, and at least one layout manager 111, as shown. GUI 607 preferably comprises at least one display region 113, and at least one event handler 603.

Functionally, layout manager 111 preferably arranges panes 110 and border regions 117 by placing state data into display memory 313 (see FIG. 1B). Widget 112 preferably refers to graphic image or icon of GUI 607 that displays information and/or generates input events that are handled by an attached EUA 602. Button 115 and widget 112 on display 352, preferably present a graphical image. User 613 selecting button 115 preferably invokes GUI 607 mechanism generating input events to EUA 620 via point/select command device 361.

Pane 110 is preferably a separate area of display region 351 (see FIG. 1A) on display 352. Layout manager 111 preferably computes and preferably lays out three-dimensional and/or two-dimensional position of all graphic images displayed in pane 110. Layout manager 111 preferably arranges graphic images like at least one button 115 and/or at least one widget 112 in pane 110 inside of window frame layout 101. Add-in host EUA 600 preferably comprises at least one layout manager 111 accessing file ID 700 (see FIG. 2A) to initialize functional and layout characteristics for at least one pane 110 and at least one border region 117. File ID 700 preferably is not limited to storing pane 110 and border region 117 initialization data and includes other initialization data for other characteristics of pane 110. Upon reading the teachings of this specification, those of ordinary skill in the art will now understand that, under appropriate circumstances, considering such issues as technology advances, purpose of the application, user then preferences, etc., other means for display, such as, holographic, electronic flexible paper, etc., may suffice.

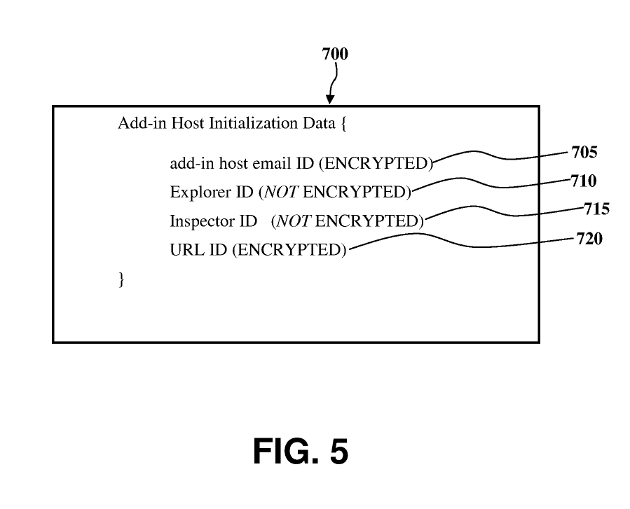

FIG. 5 shows diagrammatically all categories of initialization data record file ID 700 used by add-in host EUA 600 (see FIG. 2A). File ID 700 preferably comprises at least one add-in host email ID 705, at least one explorer ID 710, at least one inspector ID 715, and at least one URL ID 720, as shown.

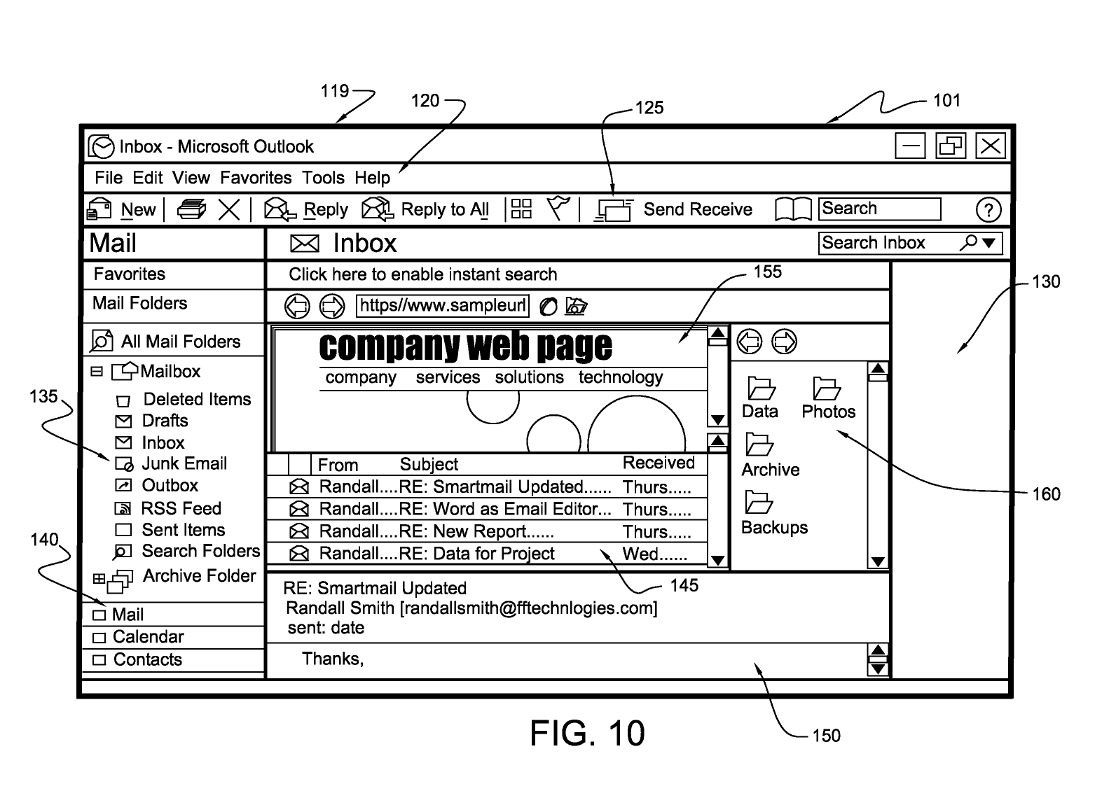

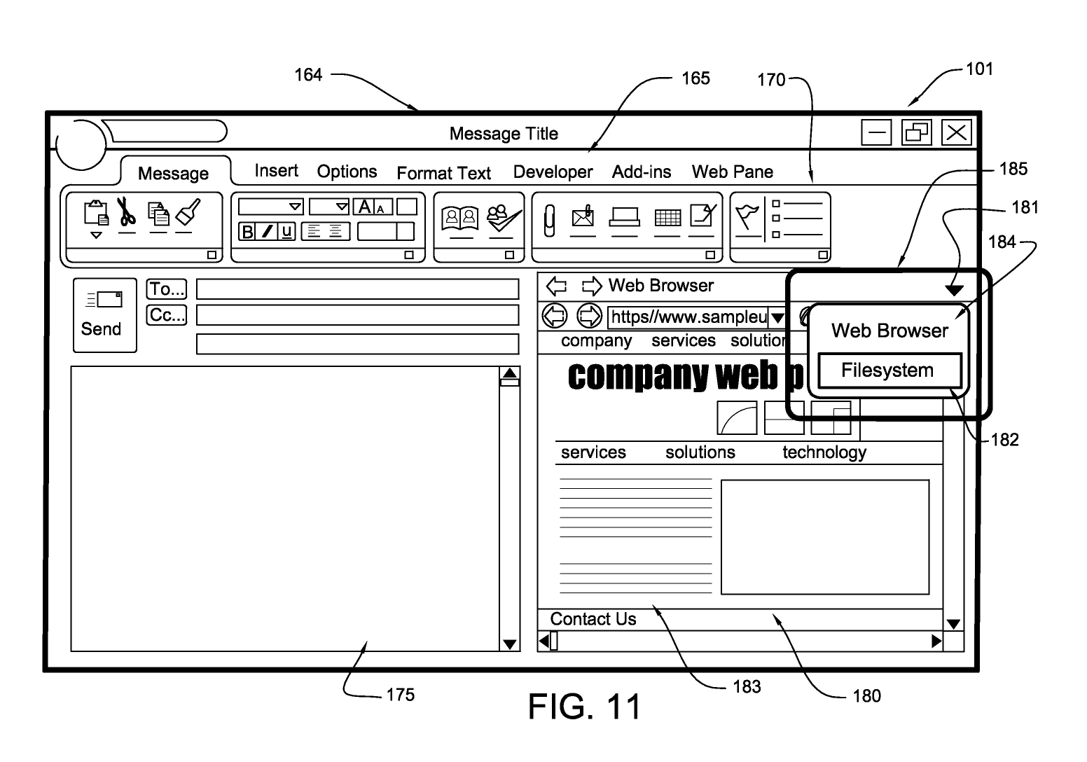

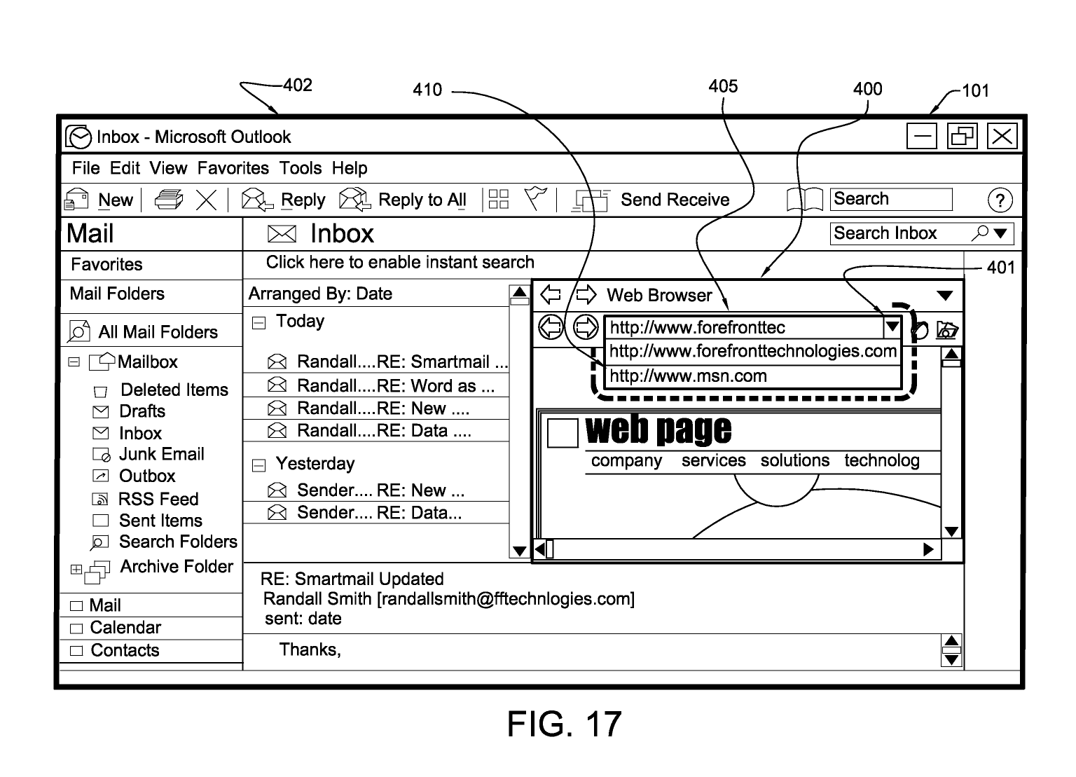

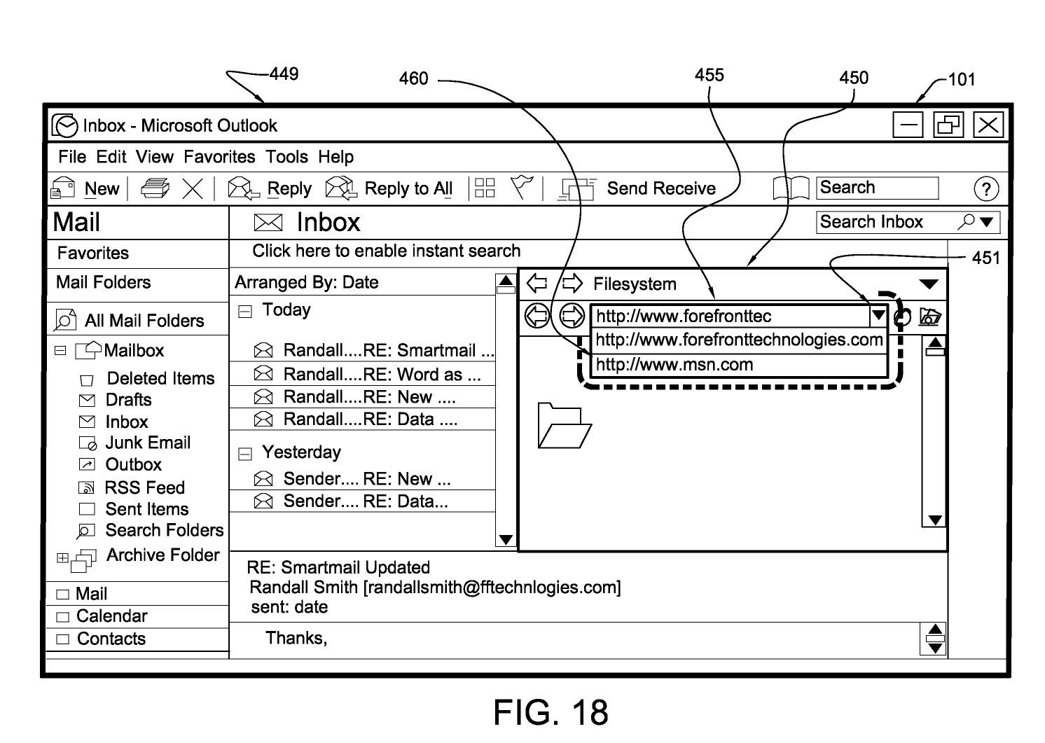

Add-in host email ID 705 preferably comprises initialization data used for administrative purposes by administrator 610. Explorer ID 710 preferably comprises initialization data used for configuration of web-browser add-in pane 155 (see FIG. 10) and filesystem-explorer add-in pane 160. Inspector ID 715 preferably comprises initialization data used for configuration of web-browser add-in pane 180 (see FIG. 11) and hidden filesystem-explorer add-in pane 183. URL is a string of characters used to represent a resource on an Internet or Intranet. URL ID 720 preferably comprises initialization data for initializing at least one URL combo box 405 of web-browser add-in pane 400 (see FIG. 17) and at least one address combo box 455 of filesystem-explorer add-in pane 450 (see FIG. 18).

FIG. 6 shows diagrammatically initialization data used by Add-in host EUA 600 for authentication. Add-in host email ID 705 initialization data record preferably comprises at least one admin username 730, at least one admin password 733, at least one new admin password 736, at least one locked field 739, at least one location field 741, at least one FTP host field 744, at least one FTP directory field 747, at least one FTP username field 749, at least one FTP password field 751, and at least one default URL field 753 is stored in a file on at least one long-term memory device 363 (see FIG. 1A) in encrypted form, as shown.

Add-in host email ID 705 is preferably accessed by at least one file data read access 606 (see FIG. 2A) and preferably stored in system memory 300 (see FIG. 1A). Add-in host email ID 705 is preferably decrypted with at least one cipher, or preferably at least one 128-bit swapping cipher. Add-in host email ID 705 used by add-in host EUA 600 for login, administrator 610 control, access to FTP host with FTP host field 744, and default URL field 753 for initializing URL combo box 405 of web-browser add-in pane 400 (see FIG. 17). Add-in host email ID 705 is preferably encrypted with at least one cipher, or at least one 128-bit swapping cipher. At least one long-term memory device 363 is preferably updated by at least one file data write access 605 preferably writing add-in host email ID 705.

Alphanumeric character array preferably comprises of at least one ASCII or preferably at least one UNICODE character. Admin username field 730 preferably comprises at least one alphanumeric character array containing username used as authentication of administrator 610 (see FIG. 2A). Admin password 733, preferably comprises at least one alphanumeric character array, preferably contains password of administrator 610 used for authentication of administrator 610. New admin password 736 preferably comprises at least one alphanumeric character array used to change admin password 733. Locked field 739 (at least embodying herein wherein such user limiter computing means comprises text field limiter computing means for limiting at least one edit property of at least one editable text field) preferably is used for locking (true) or unlocking (false) at least one add-in host EUA 600. Location field 741, preferably a alphanumeric character array, is a path that preferably locates at least one admin username 630 and at least one admin password 631 in system data registry 325 (see FIG. 1B).

FTP host field 744 preferably comprises at least one alphanumeric character array defining a URL of FTP server 341 (see FIG. 3). FTP server 341 functionality preferably is to transfer files to a requesting add-in host EUA 600. FTP directory field 747 preferably comprises at least one alphanumeric character array defining a file system directory where FTP server 341 writes and reads a file containing file ID 700 (see FIG. 2A). FTP username field 749 preferably comprises an at least one alphanumeric character array used to authenticate add-in host EUA 600 with an FTP server 341. FTP password field 751 preferably comprises at least one alphanumeric character array used to authenticate add-in host EUA 600 with an FTP server 341. Full FTP server 341 authentication of add-in host EUA 600 preferably requires at least one FTP username field 749 and at least one FTP password field 751.

Default URL field 753 preferably comprises at least one alphanumeric character array used for initializing URL combo box 405 of web-browser add-in pane 400 (see FIG. 17) with at least one URL.

Data record of add-in host email ID 705 preferably is stored, in encrypted form, in a file on at least one long-term memory device 363 (see FIG. 1A).

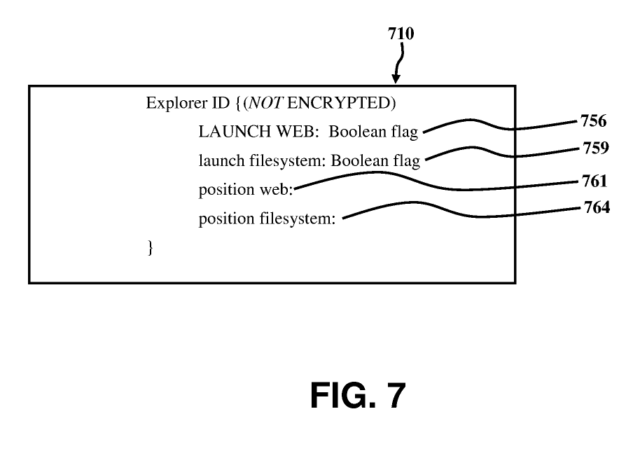

FIG. 7 shows diagrammatically initialization data of explorer ID 710 used to configure web-browser add-in pane 155 (see FIG. 10) (at least embodying herein wherein such second software application computing means comprises at least one web-browser software application) and filesystem-explorer add-in pane 160 with OUTLOOK® Explorer. Explorer ID 710 preferably comprises at least one launch web field 756, at least one launch filesystem field 759, at least one position web field 761, and at least one position filesystem field 764, as shown.

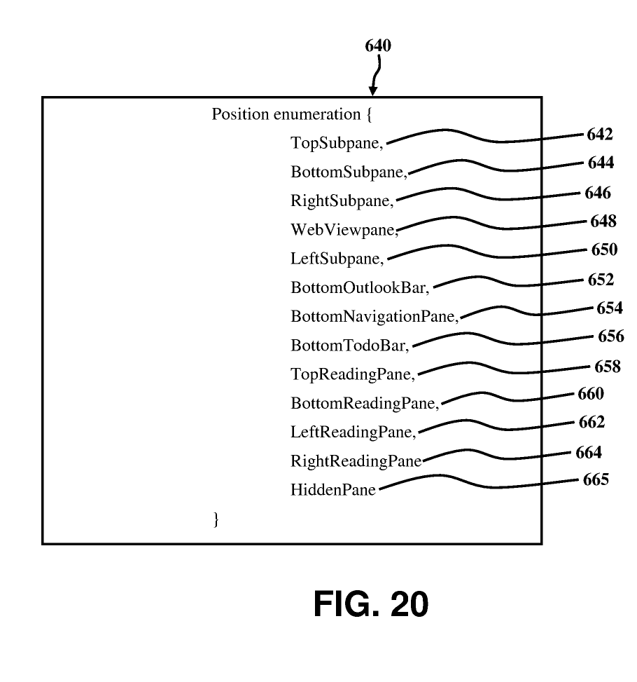

Launch web field 756 (at least embodying herein further comprising user limiter computing means for administratively limiting user access to such at least one web-browser software application) preferably is a boolean (true or false) field. Web-browser add-in pane 155 preferably is placed into at least one window frame layout 101 (see FIG. 4) when launch web field 756 is true. Filesystem-explorer add-in pane 160 is preferably placed into window frame layout 101 (see FIG. 4) when launch filesystem field 759 is true. Position web field 761 and position filesystem field 764 are preferably enumeration fields of data type position enumeration 640 (see FIG. 20). Each enumeration represents a location for pane 110 (see FIG. 4).

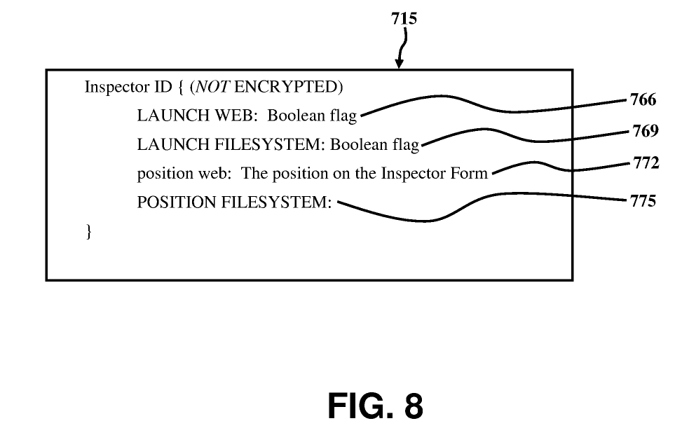

FIG. 8 shows diagrammatically initialization data of inspector ID 715 used to configure web-browser add-in pane 155 (see FIG. 10) (at least embodying herein wherein such at least one web-browser software application displays within the at least one pane of the at least one email-client software application) and filesystem-explorer add-in pane 160 (see FIG. 10) with OUTLOOK® Inspector. Inspector ID 715 preferably comprises at least one launch web field 766, at least one launch filesystem field 769, at least one position web field 772, and at least one position filesystem field 775, as shown.

Launch web field 766 preferably is a boolean (true or false) field. Web-browser add-in pane 155 preferably is placed into window frame layout 101 (see FIG. 4) when launch web field 766 is true. Filesystem-explorer add-in pane 160 preferably is placed into window frame layout 101 (see FIG. 4) when launch filesystem field 769 is true. Position web field 772 and position filesystem field 775 preferably are enumeration fields of data type position enumeration 640 (see FIG. 20). Each enumeration preferably represents a location of pane 110 (see FIG. 4).

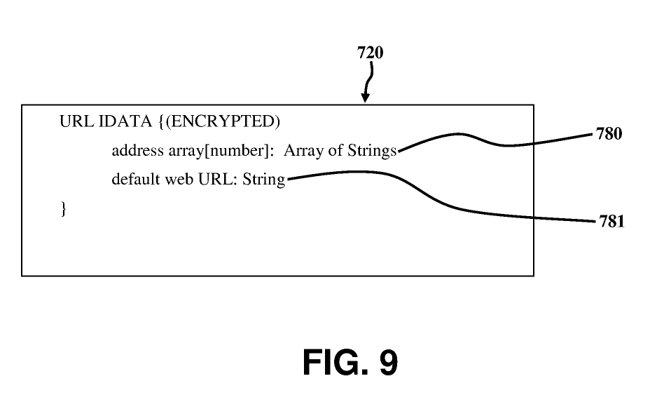

FIG. 9 shows diagrammatically initialization data of URL ID 720 that configures web browser address combo box 405 (see FIG. 17) with predefined URLs and address combo box 455 of filesystem-explorer add-in pane 450 (see FIG. 18) with filesystem paths. URL ID 720 preferably comprises at least one default web URL 781 field and at least one address array 780, as shown.

Address array 780 preferably comprises of at least one alphanumeric character array. Array elements that preferably start with characters “http”, “https,” or, alternately preferable, any constant character string, tag each element to be one of a set of URLs that initialize at least one web browser address combo box 405. Array elements that are not tagged to initialize web browser address combo box 405 are used to initialize address combo box 455 of filesystem-explorer add-in pane 450.

URL ID 720 preferably is accessed by at least one file data read access 606 (see FIG. 2A) and preferably stored in system memory 300. Add-in host email ID 705 preferably is decrypted with at least one cipher or, alternately preferable, at least one 128-bit swapping cipher. URL ID 720 preferably is encrypted with at least one cipher or, alternately preferable, at least one 128-bit swapping cipher before being written to at least one long-term memory device 363 by at least one file data write access 605 (see FIG. 2A). Default web URL 781 field preferably is used as an initial URL loaded into URL combo box 405 of web-browser add-in pane 400 (see FIG. 17) of web-browser add-in pane 400.

FIG. 10 shows a layout of panes for OUTLOOK® Explorer window frame 119 including web-browser and filesystem explorer add-in panes. OUTLOOK® Explorer window frame 119 preferably comprises at least one window frame layout 101, at least one menu bar 120, at least one tool bar 125, at least one empty add-in pane 130, at least one email folder pane 135, at least one display mode selection pane 140, at least one email folder contents pane 145, at least one email preview pane 150, at least one web-browser add-in pane 155,and at least one filesystem-explorer add-in pane 160, as shown. This depicts a preferable pane layout from a plurality of possibilities for at least one web-browser add-in pane 155 and at least one filesystem-explorer add-in pane 160. Empty add-in pane 130 preferably comprises at least one pane 110 (see FIG. 4), at least one widget 112, at least one GUI 607 (see FIG. 2A) of at least one EUA 602, at least one digital data input events 608, at least one output display data 609 supporting at least one user inputs 611, at least one graphical display information 612 for use of at least one user 613, and at least one administrator 610.

FIG. 11 shows a layout of panes for OUTLOOK® Inspector window frame 164 including web-browser and hidden filesystem explorer add-in panes. OUTLOOK® Inspector window frame 164 preferably comprises at least one window frame layout 101, at least one tab selectors for toolbars 165, at least one current selected tab toolbar 170, at least one email composer 175, at least one web-browser add-in pane 180, at least one overlay drop down pane selector menu button 181, at least one overlaid pane display selector menu 185, at least one filesystem-explorer pane selector 182, and at least one web-browser pane selector 184, as shown.

OUTLOOK® Inspector window frame 164 preferably facilitates user 613 (see FIG. 2A) access to at least one hidden filesystem-explorer add-in pane 183. OUTLOOK® Inspector window frame 164 preferably depicts a layout of pane 110 (see FIG. 4) from a plurality of possibilities for web-browser add-in pane 180 and a hidden filesystem-explorer add-in pane 183. Overlay drop down pane selector menu button 181 causes overlaid pane selector menu 185 to drop down allowing user 610 to preferably select web-browser pane selector 184 or filesystem-explorer pane selector 182 causing selected add-in to be displayed and the other to be hidden.

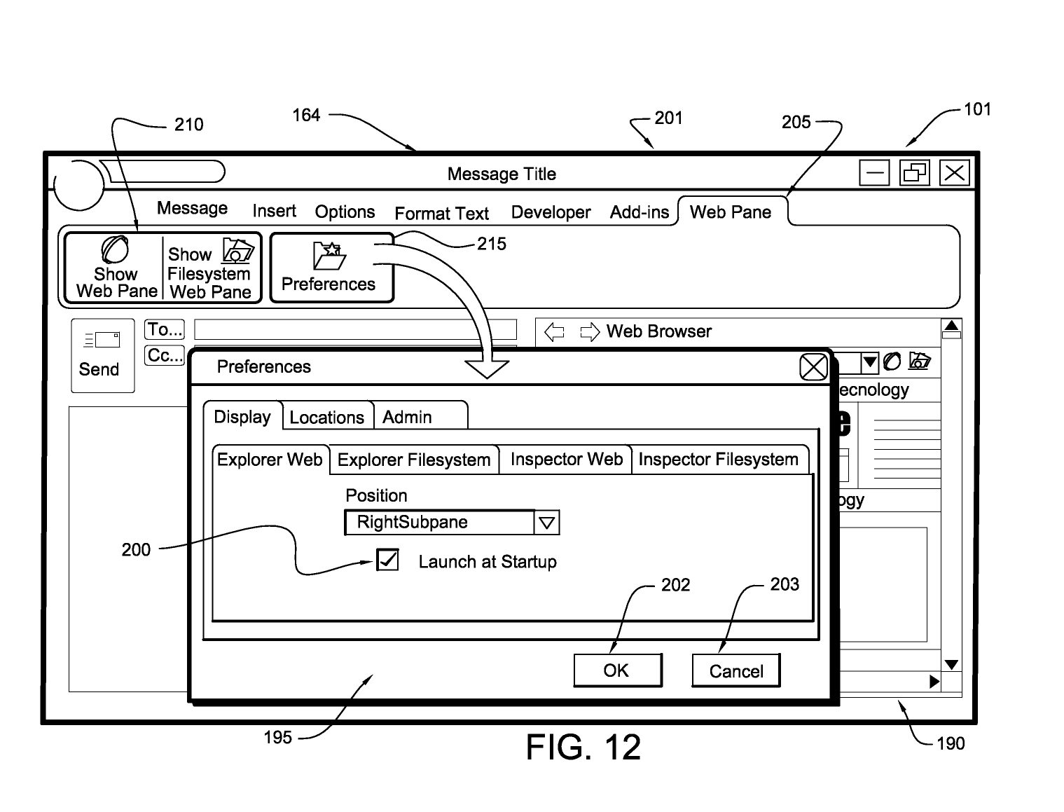

FIG. 12 shows a layout of panes 110 (see FIG. 4) for OUTLOOK® Inspector window frame 201 including web-browser add-in pane 190 and showing preferences dialog 195. OUTLOOK® Inspector window frame 201 preferably comprises at least one window frame layout 101, at least one web-browser add-in pane 190, at least one preferences dialog 195, at least one ok button 202, at least one cancel button 203, at least one launch checkbox 200, at least one web tab 205, at least one web ribbon menu 210, and at least one preferences button 215 facilitating user 613 access to configuration of preferences, as shown.

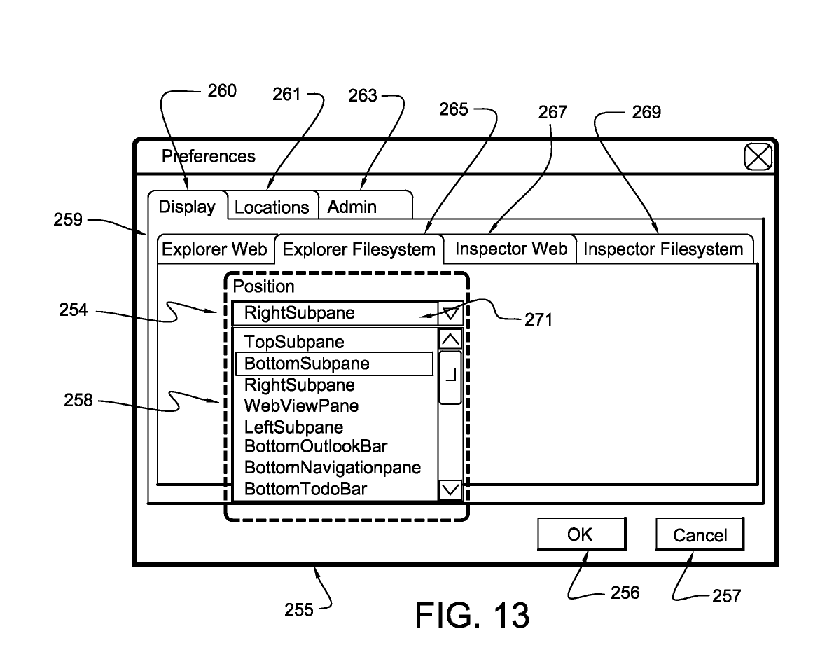

User 613 preferably selects web tab 205; this causes web ribbon menu 210 to be displayed allowing user 613 to preferably select preferences button 215 to access preferences dialog 195. User 613 preferably selects launch checkbox 200 on preferences dialog 195 displaying a checkmark; this includes web-browser add-in pane 190 in layout of OUTLOOK® Inspector window frame 201. User 613 preferably selects checkbox 200 displaying no checkmark; this causes web-browser add-in pane 190 not to be included in layout of OUTLOOK® Inspector window frame 201. Explorer web tab 259 (see FIG. 13) explorer filesystem tab 265, inspector web tab 267, and inspector filesystem tab 269 all have at least one launch checkbox 200 that preferably configures each add-in host EUA 600 for inclusion in window frame layout 101 (see FIG. 4).

User 613 preferably selecting ok button 202 applies state of launch checkbox 200 to launch web field 756 (see FIG. 7), launch filesystem field 759, launch web field 766 (see FIG. 8) or launch filesystem field 769 depending on which explorer web tab 259 (see FIG. 13), explorer filesystem tab 265, inspector web tab 267, or inspector filesystem tab 269 is selected and closes preferences dialog 195.

FIG. 13 shows preferences dialog 255 with tabs allowing access to display layout, URL locations, and administrative preference attributes. Preferences dialog 255 preferably comprises at least one ok button 256, at least one cancel button 257, at least one position combo box 254, at least one drop down position list 258, at least one explorer web tab 259, at least one display tab 260, at least one locations tab 261, at least one admin tab 263, at least one explorer filesystem tab 265, at least one inspector web tab 267, at least one inspector filesystem tab 269, and at least one drop down position selector list button 271 providing at least one user 610 and/or at least one administrator 610 access to layout preference attributes, as shown.

Preferences dialog 255 preferably operates in modal mode or, alternately preferable, non-modal mode. User 613 preferably selects display tab 260, with point/select command device 361, invoking preferences dialog 255 to present tab set comprised of explorer web tab 259, explorer filesystem 265, inspector web 267, and inspector filesystem 269. User 613 preferably selecting explorer filesystem tab 265 causing the display of position combo box 254 and drop down position selector list button 271. User 613 preferably selects drop down position selector list button 271 invoking position combo box 254 to display drop down position list 258 of position enumeration 640 (see FIG. 20). User 613 preferably selects desired identifier from position enumeration 640 configuring layout position of filesystem-explorer add-in pane 160 (see FIG. 10). User 613 preferably selects ok button 256 applying new position preference of position filesystem field 764 (see FIG. 7) and closes preferences dialog 255. User 613 preferably selecting cancel button 257 causes all preference changes to be cleared, no position preference is applied to position filesystem field 764, and closes preferences dialog 255.

User 613 preferably selecting explorer web tab 259 presents position combo box 254 and drop down position selector list button 271. User 613 preferably selecting drop down position selector list button 271 invokes position combo box 254 to display identifiers of position enumeration 640 in drop down position list 258. User 613 preferably selects desired identifier of position enumeration 640 configuring layout position of web-browser add-in pane 155 (see FIG. 10). User 613 preferably selects ok button 256 applying new position preference to position web field 761 (see FIG. 7) and closes preferences dialog 255. User 613 preferably selects cancel button 257 causing all changes to be cleared, no position preference is applied to position web field 761, and closes preferences dialog 255.

User 613 preferably selects inspector web tab 267 presenting position combo box 254 and drop down position selector list button 271. User 613 preferably selects drop down position selector list button 271 invoking position combo box 254 to present identifiers of position enumeration 640 in drop down position list 258. User 613 preferably selects desired identifier of position enumeration 640 configuring layout position of web-browser add-in pane 180 (see FIG. 11). User 613 preferably selects ok button 256 applying new position preference to position web 772 (see FIG. 8) and closes preferences dialog 255. User 613 preferably selects cancel button 257 causing all changes to be cleared, no position preference is applied to position web 772, and closes preferences dialog 255.

User 613 preferably selects inspector filesystem tab 269 presenting position combo box 254 and drop down position selector list button 271. User 613 preferably selects drop down position selector list button 271 invoking position combo box 254 to display identifiers of position enumeration 640 in drop down position list 258. User 613 preferably selects desired identifier of position enumeration 640 configuring layout position of filesystem-explorer add-in pane 200 (see FIG. 12). User 613 preferably selects ok button 256 applying new position preferences to field position filesystem 775 (see FIG. 8) and closes preferences dialog 255. User 613 preferably selects cancel button 257 causing all changes to be cleared, no position preferences to be applied to position filesystem 775, and closes preferences dialog 255.

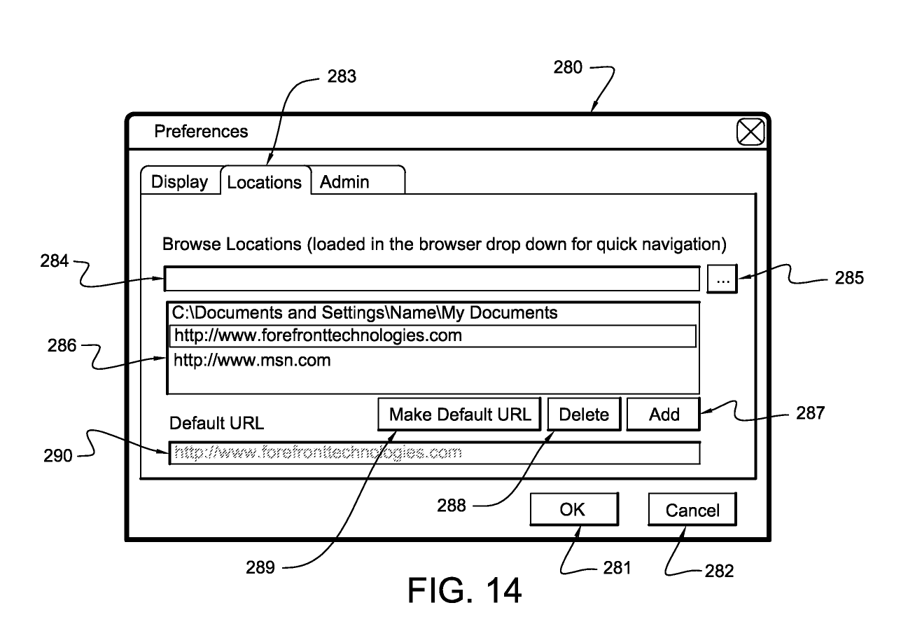

FIG. 14 shows preferences dialog 280 allowing defining of web URLs and file addresses to initialize web and filesystem add-in address combo boxes. Preferences dialog 280 preferably comprises at least one ok button 281, at least one cancel button 282, at least one locations tab 283, at least one edit textbox 284, at least one file browser button 285, at least one address listbox 286, at least one add button 287, at least one delete button 288, at least one make default URL button 289, and at least one default URL textbox 290, as shown.

Administrator 610 preferably pre-defines URLs and file addresses for use in URL combo box 405 of web-browser add-in pane 400 (see FIG. 17) and address combo box 455 of filesystem-explorer add-in pane 450 (see FIG. 18). Preferences dialog 280 preferably operates in modal mode or, alternately preferable, non-modal mode. User 613, upon selecting file browser button 285, preferably opens a file browser allowing movement through directories of a file system, local file path or, alternately preferable, networked file path, and selecting a directory path. A selected directory path is placed in edit textbox 284 on exit of file browser. User 613 preferably edits directory path in edit textbox 284. Contents of edit textbox 284 are copied to address listbox 286 when user 613 selects add button 287. User 613 preferably enters a URL directly into edit textbox 284 and when selecting add button 287 copies contents of edit textbox 284 to address listbox 286.

User 613 preferably selecting a URL or file address in address listbox 286 can delete it from address listbox 286 by selecting delete button 288. User 613 preferably defines a default URL by selecting a URL in address listbox 286 and then selecting make default URL button 289 copying selected URL value into default URL textbox 290. User 613 preferably selects ok button 281 copying new address preferences to address array 780 (see FIG. 9), copying contents of default URL textbox 290 to default web URL 781, and closes preferences dialog 255. User 613 preferably selects cancel button 282 causing all address changes to be cleared, no predefined addresses to be copied to address array 780 or default web URL 781, and closes preferences dialog 280.

FIG. 15 shows preferences dialog 370 that allows setting of add-in host lock, administrator username and password. Preferences dialog 370 comprises at least one admin tab 371, at least one admin tab pane 389 comprising at least one cancel button 372, at least one ok button 373, at least one postman textbox 374, at least one mail key textbox 375, at least one lock checkbox 377, at least one new mail key textbox 379, at least one FTP user textbox 380, at least one FTP password textbox 382, at least one pref register key 383, at least one FTP host textbox 385, at least one FTP directory textbox 386, and at least one distribute ini button 388, as shown.

Preferences dialog 370 preferably operates in modal mode or, alternately preferable, non-modal mode. Administrator 610 (see FIG. 2A) preferably, using point/select command device 361 (see FIG. 1A), selects admin tab 371 of preferences dialog 370 causing GUI 607 (see FIG. 2A) to display admin tab pane 389. All fields of admin tab pane 389 are initialized with their respective values from add-in host email ID 705 (see FIG. 6).

Administrator 610, using point/select command device 361, preferably selects postman textbox 374 and, by typing, enters account name of administrator 610. Administrator 610 preferably selects mail key textbox 375 then, by typing, enters a password. Authentication of administrator 610 preferably requires a comparison and match of contents of postman textbox 374 with admin username 730 (see FIG. 6) and mail key textbox 375 with admin password 733 (see FIG. 6) by add-in host EUA 600. Administrator 610 preferably selects lock checkbox 377, making it checked, puts add-in host EUA 600 in lock down mode. Lock checkbox 377 state is saved to locked field 739 (see FIG. 6) when administrator 610 preferably selects ok button 373, provided administrator 610 is authenticated.

Administrator 610 preferably selects new mail key textbox 379 and, by typing, enters a new password. New mail key textbox 379 contents are saved in new admin password 736 (see FIG. 6) and admin password 733 when administrator 610 preferably selects ok button 373, provided administrator 610 is authenticated.

Administrator 610 preferably selects FTP host textbox 385 and by typing, enters a URL for FTP server 341 (see FIG. 3). Contents of FTP host textbox 385 is saved to FTP host field 744 (see FIG. 6) when administrator 610 preferably selects ok button 373, provided administrator 610 is authenticated.

Administrator 610 preferably selects FTP directory textbox 386 and by typing, enters a directory path. Contents of FTP directory textbox 386 is saved to FTP directory field 747 (see FIG. 6) when administrator 610 selects ok button 373, provided administrator 610 is authenticated.

Administrator 610 preferably selects FTP user textbox 380 and, by typing, enters a user account name for FTP server 341. Contents of FTP user textbox 380 is saved to FTP username field 749 (see FIG. 6) when administrator 610 selects ok button 373, provided administrator 610 is authenticated.

Administrator 610 preferably selects FTP password textbox 382 and, by typing, enters a user account password for FTP server 341. Contents of FTP password textbox 382 is saved to FTP password field 751 (see FIG. 6) when administrator 610 selects ok button 373, provided administrator 610 is authenticated.

Administrator 610 preferably selects ok button 373 will save all admin tab pane 389 fields to corresponding field of add-in host email ID 705 (see FIG. 6), providing administrator 610 is authenticated. Add-in host EUA 600 (see FIG. 2A) writes an updated copy of file ID 700, ADDINHOST.INI, via file data write access 605 completing ok button 373 processing.

Administrator 610 preferably selects Distribute INI button 388 causing a copy of local file ID 700, ADDINHOST.INI, file to be copied to FTP directory defined by FTP directory field 747 (see FIG. 6), provided administrator 610 is authenticated.

Administrator 610 selecting cancel button 372 causes changes of admin tab pane 389 savable fields not to be saved before closing processing of preferences dialog 370.

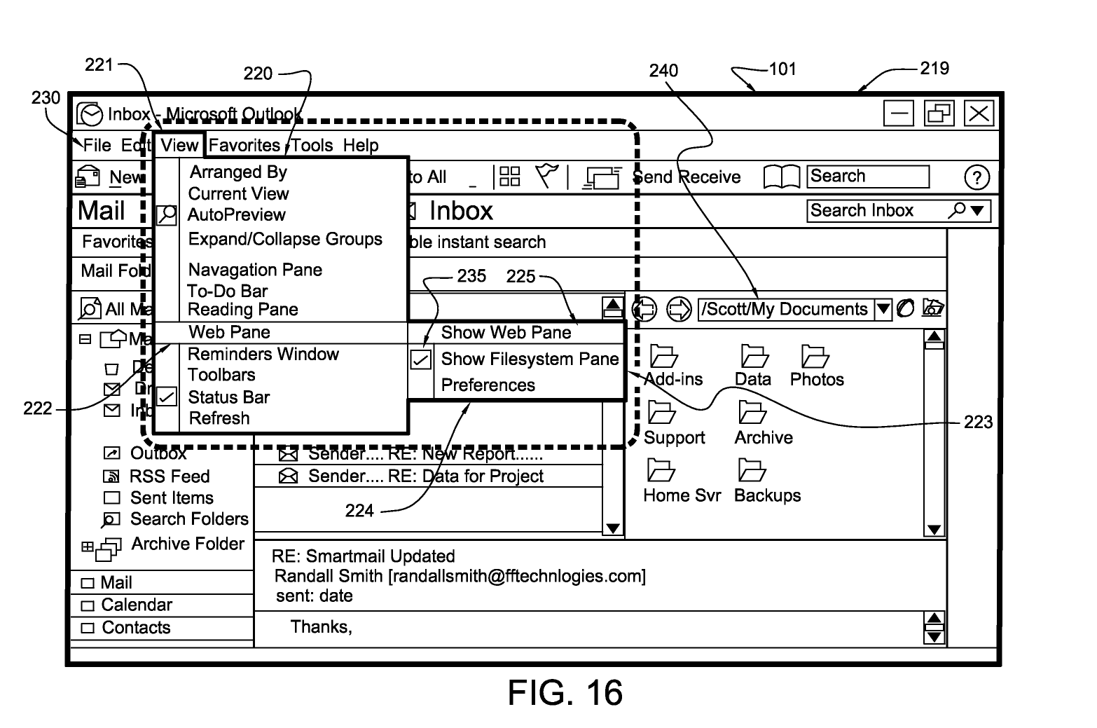

FIG. 16 shows diagrammatically OUTLOOK® explorer window frame 219 and menu items to access preference configuration. OUTLOOK® Explorer window frame 219 preferably comprises at least one window frame layout 101 (see FIG. 4), at least one view dropdown menu 220, at least one view menu button 221, at least one web pane menu 222, at least one show filesystem pane 223, at least one preferences item 224, at least one show web pane 225, at least one menu bar 230, at least one selected check 235, and at least one filesystem-explorer display pane 240 allowing user 613 to configure preferences, as shown.

User 613 preferably selects view menu button 221 located on menu bar 230 causing view dropdown menu 220 to display. After such, user 613 preferably selects web pane menu 222 causing show web pane 225, show filesystem pane 223, and preferences item 224 to display. User 613 preferably selects show filesystem pane 223 toggling layout position configuration of filesystem-explorer display pane 240 and saving new position enumeration 640 (see FIG. 20) in position filesystem field 764 (see FIG. 7). User 613 preferably selects show web pane 225 toggling layout position of configuration of web-browser add-in pane 155 (see FIG. 10) and saving new position enumeration 640 in position web field 761 (see FIG. 7).

User 613 preferably selects preferences item 224 of web pane menu 222 causing preferences dialog 255 (see FIG. 13) to be displayed by GUI 607 (see FIG. 2A) allowing configuration of preferences.

FIG. 17 shows diagrammatically OUTLOOK® Explorer window frame 402 with URL combo box 405 of web-browser add-in pane 400. OUTLOOK® Explorer window frame 402 preferably comprises at least one window frame layout 101 (see FIG. 4), at least one web-browser add-in pane 400, at least one drop-down listbox button 401, at least one web-browser URL combo box 405, and at least one drop-down URL listbox 410 for demonstrating administrative control capabilities of add-in host EUA 600 (see FIG. 2A), as shown. User 613 preferably selects drop-down listbox button 401 causing drop-down URL listbox 410 to drop down. User 613 preferably selects a URL for web-browser add-in pane 400 to navigate too. User 613 preferably selects URL combo box 405 of web-browser add-in pane 400 and then entering, by typing, a URL to navigate too, provided locked field 739 (see FIG. 6) is not locked. Locked field 739, in locked state, limits user 613 to only selecting URLs preloaded in drop-down URL listbox 410 initialized from address array 780 (see FIG. 9).

Administrator 610 (see FIG. 2A) preferably controls state of locked field 739 via lock checkbox 377 of preferences dialog 370 (see FIG. 15) facilitating operational configuration of URL combo box 405 of web-browser add-in pane 400 controlling capabilities user 613 has available. Upon reading the teachings of this specification, those of ordinary skill in the art will now understand that, under appropriate circumstances, considering such issues as technology advances, purpose of the application, user then preferences, etc., other functionality of the add-in or add-in host EUA's may be administered, such as configuring GUI features of EUA, controlling GUI widgets of EUA, controlling GUI events handled by EUA, controlling functionality of EUA available for use, etc., may suffice.

FIG. 18 shows diagrammatically OUTLOOK® Explorer window frame 449 with address combo box 455 of filesystem-explorer add-in pane 450. OUTLOOK® Explorer window frame 449 preferably comprises at least one window frame layout 101 (see FIG. 4), at least one filesystem-explorer add-in pane 450, at least one drop-down listbox button 451, at least one address combo box 455, and at least one drop-down directory path listbox 460, for demonstrating administrative control capabilities of add-in host EUA 600 (see FIG. 2A), as shown.

User 613 preferably selects drop-down listbox button 451 causing drop-down directory path listbox 460 to drop down. User 613 preferably selects a directory path for filesystem-explorer add-in pane 450 to navigate too. User 613 preferably selects address combo box 455 of filesystem-explorer add-in pane 450 and entering, by typing, a directory path to navigate too, provided locked field 739 (see FIG. 6) is not in a locked state. Locked field 739 in locked state preferably limits user 613 to only selecting directory paths preloaded in drop-down directory path listbox 460 from address array 780 (see FIG. 9). Administrator 610 (see FIG. 2A) preferably controls locked field 739 state via lock checkbox 377 (see FIG. 15) of preferences dialog 370 facilitating operational configuration of address combo box 455 of filesystem-explorer add-in pane 450 controlling capabilities user 613 has available.

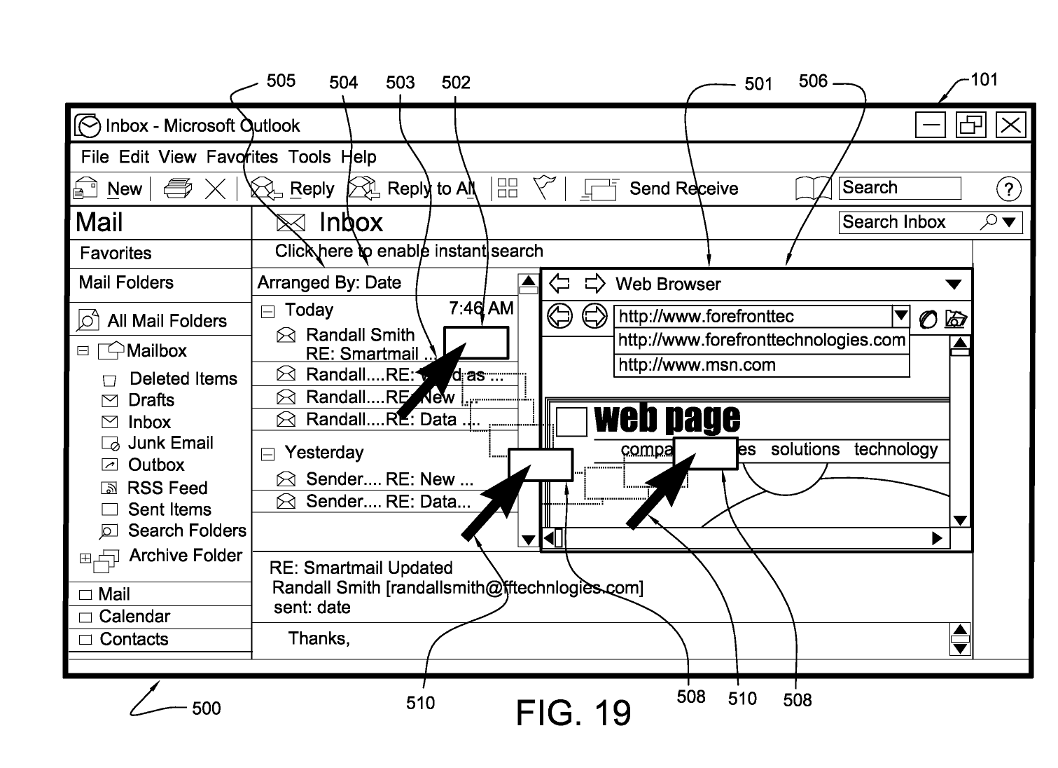

FIG. 19 shows diagrammatically OUTLOOK® email EUA add-in in-box 505 transferring data to web-browser database client 506. OUTLOOK® Explorer window frame 500 preferably comprises at least one add-in pane 501, at least one web-browser database client 506, at least one email attachment icon 502, at least one controlled cursor 503, at least one add-in pane 504 of EUA 602, at least one email EUA add-in in-box 505, at least one copied email attachment icon 508, and at least one controlled cursor movement 510 demonstrating user 613 drag-and-drop capability with controlled point/select command device 361 (see FIG. 1A) invoking data transfer event 617 (see FIG. 2A), as shown.

OUTLOOK® Explorer window frame 500 (at least embodying herein wherein such first software application computing means comprises at least one email-client software application) comprised of window frame layout 101 (see FIG. 4) with at least one single layout manager 111 facilitating an always visible pane 110 of GUI 607 for each EUA 602. This preferred pane 110 layout facilitates a drag-and-drop event of GUI 607 between any pair of add-in pane 501 of EUA 602 resulting in data transfer event 617. If panes 101 are hidden then a copy-and-paste technique must be used to facilitate data transfer event 617 requiring more manipulation by user 613.

Data transfer event 617 preferably occurs between add-in pane 504 of EUA 602, and preferably at least one email EUA add-in in-box 505, resulting from user 613 preferably selecting and holding email attachment icon 502 with controlled cursor 503 using point/select command device 361 (see FIG. 1) (at least embodying herein icon selector computing means for selecting, using the point/select/command device, within the at least one first display pane, the at least one data icon). User 613 preferably drags controlled cursor movements 510 with email attachment icon 508 over add-in pane 501 of EUA 602 (at least embodying herein icon mover computing means for moving, using the point/select/command device, the at least one data icon from the at least one first display pane to the at least one second display pane), alternately preferably, at least one web-browser database client 506 (at least embodying herein such at least one web-browser software application comprises at least one database client software application). User 613 preferably releases controlled cursor movements 510 dropping email attachment icon 502 generating data transfer event 617 (at least embodying herein icon releaser computing means for releasing, using the point/select/command device, within the at least one second display pane, the at least one data icon).

User 613 dropping email attachment icon 502 preferably provides context sensitive digital data input events 608 (see FIG. 2A) invoking data transfer event 617. Data transfer event 617 is communicated to event handler 603 of EUA 602 of web-browser database client 506. Event handler 603 gets a handle to a file from email attachment icon 508 and performs EUA 602 specific processing (at least embodying herein wherein such icon releaser computing means comprises information classifier computing means for classifying the useful information to categorize any metadata to provide metadata classification information). Event handler 603 of EUA 602 (at least embodying herein information transfer computing means for transferring the useful information and any associated metadata classification information to the second software application) specific processing preferably comprises at least one determination of file type (at least embodying herein wherein such any associated at least one metadata classification information comprises at least one user-selected data extension file type), at least one extraction of data records from a file and at least one write of data record into an INTELLIDOX® database (at least embodying herein such information transfer computing means transfers the useful information and such any associated at least one metadata classification information to such at least one database client software application). Upon reading the teachings of this specification, those of ordinary skill in the art will now understand that, under appropriate circumstances, considering such issues as technology advances, purpose of the application, user then preferences, etc., other event handler processing for the EUA, such as may be determined base on criteria like parsing meta data of the transfer event, and where such meta data may include: the source EUA, URL of the web browser, examining header information read from the file, examining and categorizing the data in the file, command message contained in the file resulting in data being returned to the source EUA, pseudo attachment file commanding retrieval of information from the target EUA, etc., may suffice.

FIG. 20 shows diagrammatically position enumeration 640 states specifying layout position of pane 110, preferably three-dimensionally or preferably two-dimensionally, in window frame layout 101. Position enumeration 640 preferably comprises at least one TopSubpane 642, at least one BottomSubpane 644, at least one RightSubpane 646, at least one WebViewpane 648, at least one LeftSubpane 650, at least one BottomOutlookBar 652, at least one BottomNavigationPane 654, at least one BottomTodoBar 656, at least one TopReadingPane 658, at least one BottomReadingPane 660, at least one LeftReadingPane 662, at least one RightReadingPane 664, and at least one HiddenPane 665 defining location of at least one pane 110 (see FIG. 4) in at least one window frame layout 101, as shown.

Position of pane 110 in window frame layout 101 are specified preferably three-dimensionally or two-dimensionally consistent with capabilities of GUI 607 (see FIG. 2A) and display 352 (see FIG. 1A) with identifiers of position enumeration 640.

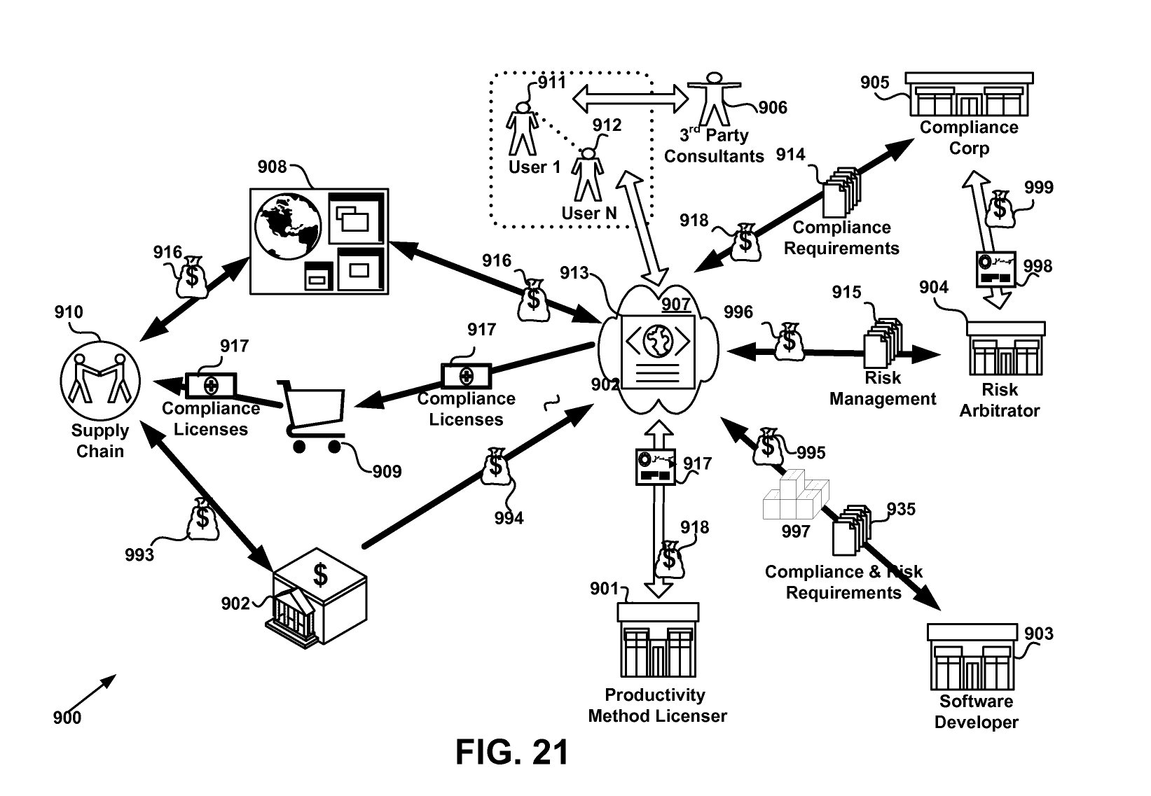

FIG. 21 shows an overall schematic illustration, of a productivity method licensor 901 enabling increased productivity of data transfer between email and web-enabled database, according to a preferred embodiment of the present invention. As depicted in FIG. 21, at a high level of abstraction, preferably licensor productivity system 900 may be modeled as a number of stakeholders interconnected via a hub, performance messaging site, shown as compliant messaging site 913. Stakeholders comprise productivity method licensor 901, User 1 911, compliance company 905, User N 912, supply chain 910, 3rd party consultants 906, risk arbitrator 931, and software developer 903, as shown. Enablers comprise electronic commerce interface 908, electronic shopping cart 909, merchant bank 902, and compliant messaging site 913, as shown. Productivity method licensor 901 authorizes and provides management and enabling functions for the other stakeholders of productivity system 900.

Preferably, productivity method licensor 901, through compliant messaging site 913, provides a means, and monetizes the means, for User 1 911 to communicate with User N 912, supply chain 910, 3rd party consultants 906, and/or compliance company 905. Additionally, preferably, productivity method licensor 901, through compliant messaging site 913, provides a means, and monetizes the means, for compliance company 905 to enable compliance requirements 914 of User 1 911 and/or 3rd party consultants 906. Further, preferably, productivity method licensor 901, through compliant messaging site 913, provides a means, and monetizes the means, for risk arbitrator 931 to enable risk management 915 associated activities of User 1 911, 3rd party consultants 906, compliance company 905 and/or software developer 903. Further, preferably, productivity method licensor 901 provides compliance requirements 914 and risk management 915 as compliance and risk requirements 935 to software developer 903 for software implementation 997. Further, preferably, productivity method licensor 901 pays software developer 903 for the software implementation 997 with payment 995. Software developer 903 preferably implements software implementation 997 (i.e. the desirable implementation of EUA 602) with administrative controls and auditing capabilities complementary of compliance and risk requirements 935.

Further referring to FIG. 21, preferably, supply chain 910 may retrieve payment message 916 by interfacing with electronic commerce interface 908, electronic shopping cart 909, and merchant bank 902. In a preferred embodiment, supply chain 910 queries electronic commerce interface 908 via Internet 907, wherein electronic commerce interface 908 is linked to compliant messaging site 913, and wherein payment message 916 is also linked to compliant messaging site 913. Preferably, electronic commerce interface 908 is configured such that supply chain 910, when enabled with predetermined credentials and/or by having made predetermined payments, may query for User N 912, and further may query for payment message 916 that are associated with User N 912. Further, preferably, compliant messaging site 913 comprises necessary means to assure that only compliance licenses 917, associated with User N 912, may be accessed by supply chain 910. Once supply chain 910 has located compliance licenses 917, associated with User N 912, then compliant messaging site 913 offers to deliver such compliance licenses 917 to supply chain 910. Preferably, such offering is accomplished by supply chain 910 using electronic shopping cart 909 to select from available compliance licenses 917 and paying for the deliver payment message 993 via merchant bank 902. Preferably, electronic commerce interface 908 may be electronically interfaced, through compliant messaging site 913, to User 1 911, compliance company 905, software developer 903, and/or risk arbitrator 931.

Again referring to FIG. 21, preferably, compliance company 905 and risk arbitrator 904 may query compliant messaging site 913 relative to compliance requirements 914 of User 1 911. Preferably, in return for the benefits of compliance requirements 914 to compliance company 905, compliance company 905 provides payment 918 to productivity method licensor 901. Risk arbitrator 904 preferably provides insurance policy 998 to compliance company 905 for a reduced payment 999 for consideration of enforcement of compliance requirements 914 and risk management 915. Risk arbitrator 904 preferably provides insurance policy 998 to compliance company 905 for a reduced payment 999 for consideration of enforcement of compliance requirements 914 and risk management 915.

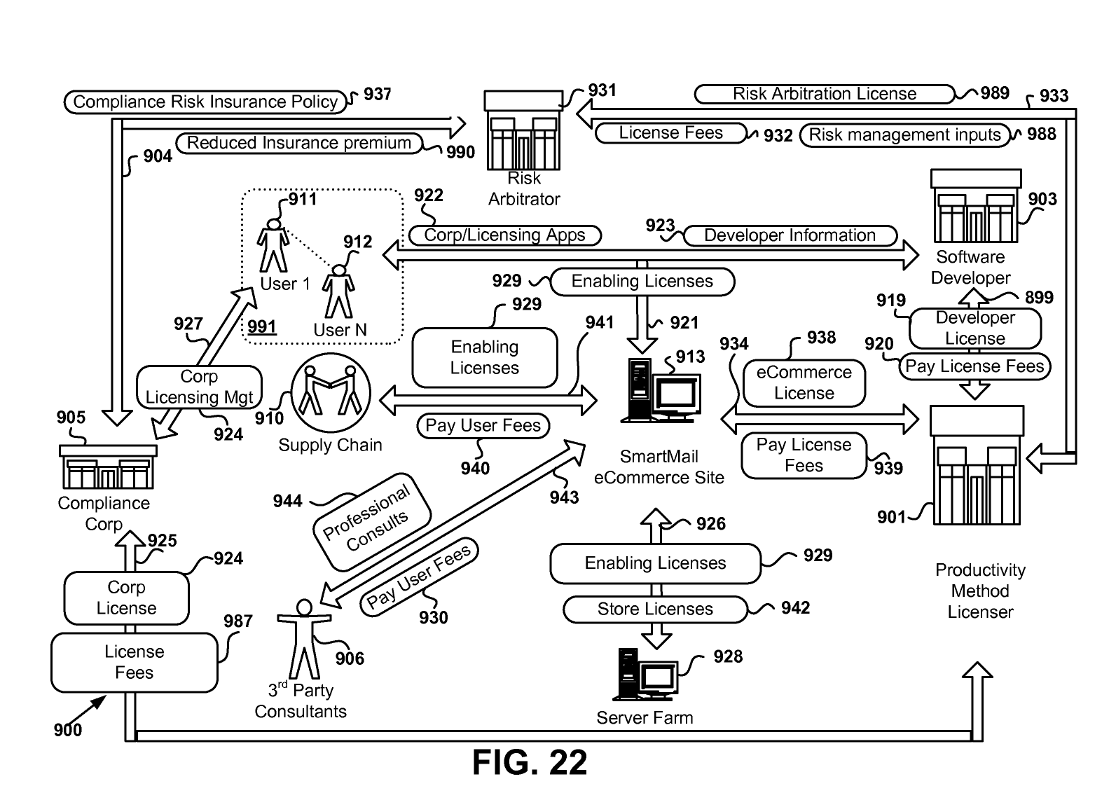

FIG. 22 shows a schematic illustration, of a business method for enabling productivity method licensor 901, compliance requirements 914 and risk management 915, according to the preferred embodiment of FIG. 21. Preferably, directly monetizing the use of productivity system 900, preferably, this direct monetizing is accomplished, in part, by productivity method licensor 901 providing developer license 919 to software developer 903 in return for software developer 903 providing pay license fees 920 to productivity method licensor 901 on connection 899, as shown. Additionally, preferably, developer license 919 enables software developer 903 to perform company-licensing applications 922, developer information 923 for productivity system 900 via compliant messaging site 913, preferably by connection 921, as shown.

Additionally, preferably, as part of method 900 directly monetizing at least one use of productivity system 900, company license 924 enables compliance company 905 by connection 925, connection 927, connection 921 and connection 926, as shown. Preferably, this connectivity is such that User 1 911 may input compliance licenses 917, associated with User N 912, into server farm 928 preferably via compliant messaging site 913. Preferably, this connectivity is such that compliance company 905 has availability to enabling licenses 929 in server farm 928, as shown. Additionally, preferably, company license 924 enables compliance company 905 to link through connection 921 preferably to software developer 903. Preferably, this connectivity is such that compliance company 905 has availability to records of User N 912 housed within software developer 903. Further, preferably, company license 924 enables compliance company 905 to link to 3rd party consultants 906 by connection 930. Additionally, preferably, company license 924 enables compliance company 905 to link through connection 927 to User 1 911, and through connection 904 to risk arbitrator 931. Additionally, preferably, compliance company 905 pays license fees 987 to productivity method licensor 901 in consideration for use of company license 924. Upon reading the teachings of this specification, those with ordinary skill in the art will now understand that, under appropriate circumstances, considering issues such as changes in technology, connectivity, server capabilities, user requirements/needs, etc., other eCommerce system connectivities for company license, such as, for example, portable wireless connectivity links, virtual connections, and/or security service elements, yet to be developed, etc., may suffice.

Preferably, as part of method 900 directly monetizing at least one use of productivity system 900, productivity system 900 enables risk arbitrator 931 (having paid license fees 932) to have remote connectivity to compliance company 905, preferably by connection 904 and to software developer 903, preferably by connection 933 to connection 934 through compliant messaging site 913. Preferably, this connectivity enables inputting at least one risk management input 936 into productivity system 900 for compliance company 905. Additionally, preferably, risk arbitrator 931 provides risk management inputs 988 and license fees 932 to productivity method licensor 901 to receive risk arbitration license 989 utilizing connection 933. Additionally, preferably, this connectivity enables connectivity to server farm 928, by connection 926 as shown. Thus, method 900 directly monetizes at least one use of compliance license 917 via insurance policy 937 for reduced insurance premium 990. Upon reading the teachings of this specification, those with ordinary skill in the art will now understand that, under appropriate circumstances, considering issues such as changes in technology, connectivity, server capabilities, user requirements/needs, etc., other eCommerce system connectivities for risk arbitrator, such as, for example, portable wireless connectivity links, virtual connections, and/or security service elements, yet to be developed, etc., may suffice.

Further, referring to FIG. 22, preferably, method 900 comprises directly monetizing use of eCommerce license 938 by providing connection 934 to compliant messaging site 913 in return for compliant messaging site 913 providing ecommerce-license fees 939, as shown, to productivity method licensor 901. Preferably, compliant messaging site 913 also provides eCommerce connectivity, as shown, to supply chain 910. Preferably, supply chain 910 provides enabling licenses 929 to compliance company 905 in return for pay user fee 940. Preferably, in return supply chain 910 provides pay user fee 940, as shown, to compliant messaging site 913. Thus, preferably, productivity system 900 enables remote connecting of supply chain 910, preferably by connection 941 to compliant messaging site 913. This preferred connectivity, when coupled with analytics of compliant messaging site 913 and server farm 928, preferably enables enabling licenses 929 was well as license storage 942 for supply chain 910, as shown in FIG. 22. Upon reading the teachings of this specification, those with ordinary skill in the art will now understand that, under appropriate circumstances, considering issues such as changes in technology, connectivity, server capabilities, user requirements/needs, etc., other eCommerce system connectivities for compliant messaging site, such as, for example, portable wireless connectivity links, virtual connections, and/or security service elements, yet to be developed, etc., may suffice.

Additionally, referring to FIG. 22, compliant messaging site 913 preferably provides connectivity to 3rd party consultants 906 via link 943, as shown. Using link 943 3rd party consultants 906 conduct inputs for professional consults 944, as shown. Upon reading the teachings of this specification, those with ordinary skill in the art will now understand that, under appropriate circumstances, considering issues such as changes in technology, connectivity, server capabilities, user requirements/needs, etc., other related system connectivity for ecommerce-based professional consults, such as, for example, portable wireless connectivity links, virtual connections, and/or security service elements, yet to be developed, etc., may suffice.

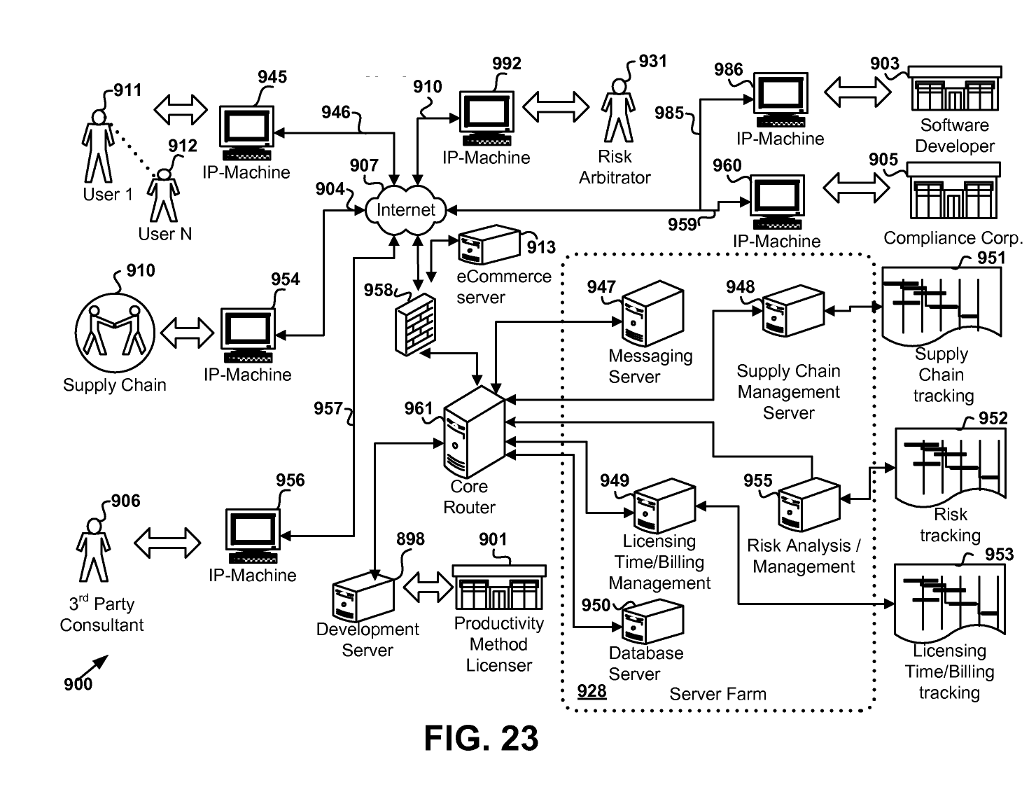

FIG. 23 shows a functional illustration, of a preferred implementation of a preferred business method for enabling productivity method licensor 901, compliance requirements 914 and risk management 915, according to the preferred embodiment of FIG. 22. The functional illustration of preferred business method for enabling productivity method licensor 901, compliance requirements 914 and risk management 915, shown in FIG. 23, is identified as method 900.

Preferably, User 1 911 and/or User N 912 utilize IP machine 945 to interface with productivity system 900, as shown. User interface IP machine 945 preferably provides User 1 911 and/or User N 912 with authenticating and establishing authorized functions, as shown. Preferably, IP machine 945 enables User 1 911 and/or User N 912 to access compliant messaging site 913 via communication link 946 and Internet 907 through firewall 958. Upon reading the teachings of this specification, those with ordinary skill in the art will now understand that, under appropriate circumstances, considering issues such as changes in technology, user requirements/needs, eCommerce legislation, Internet security measures, etc., other eCommerce system connectivity for User 1 and/or User N, such as, for example, portable wirelessly connected user-interface managers, virtual connections from user-interface elements to back-office billing, settlement, and/or security service elements yet to be developed, etc., may suffice.

Preferably, once User 1 911 and/or User N 912 connects to compliant messaging site 913, User 1 911 and/or User N 912 has access to functionality of, supply chain management server 948, licensing time/billing management 949, and database server 950, as shown, in server farm 928. Upon reading the teachings of this specification, those with ordinary skill in the art will now understand that, under appropriate circumstances, considering issues such as changes in technology, user requirements/needs, Internet security measures, eCommerce legislation, etc., other configurations of sever farm, such as multiple or virtual server configurations, virtual connections from user interface elements to security service elements and/or databases, etc., may suffice.

Preferably, the above-stated connectivity also allows User 1 911 to view supply chain tracking 951, risk tracking 952, and licensing time/billing tracking 953.

Additionally, FIG. 23 shows how supply chain 910 utilizes IP machine 954 to interface with productivity system 900. Preferably, IP machine 954 allows supply chain 910 to authenticate and establish authorized functions, as shown. Upon reading the teachings of this specification, those with ordinary skill in the art will now understand that, under appropriate circumstances, considering issues such as changes in technology, user requirements/needs, Internet security measures, eCommerce legislation, etc., other configurations of eCommerce system connectivity for supply chain, such as virtual connections that facilitate authentication and authorization for supply chain to server farm may suffice.

Preferably, utilizing IP machine 954, supply chain 910 is enabled to access compliant messaging site 913 via risk arbitrator 931 and Internet 907 through firewall 958. Preferably, once supply chain 910 connects to compliant messaging site 913, supply chain 910 has access to functionality of messaging server 947, supply chain management server 948, licensing time/billing management server 949, risk analysis server 955 and database server 950, as shown, in server farm 928. Upon reading the teachings of this specification, those with ordinary skill in the art will now understand that, under appropriate circumstances, considering issues such as changes in technology, user requirements/needs, Internet security measures, eCommerce legislation, etc., other configurations of eCommerce system connectivity for supply chain, such as, for example, virtual connections that facilitate authentication and authorization for supply chain to server farm, etc., may suffice

Additionally, FIG. 23 shows how 3rd party consultants 906 utilize IP (i.e., Internet Protocol) machine 956 to interface with productivity system 900. IP machine 956, preferably, allows 3rd party consultants 906 to authenticate and establish authorized functions, as shown. Preferably, IP machine 956 enables 3rd party consultants 906 to connect to Internet 907, as shown.

Utilizing IP machine 956, preferably, enables 3rd party consultants 906 to access compliant messaging site 913 via communication link 957 and Internet 907 through firewall 958. Preferably, once 3rd party consultant 906 connect to compliant messaging site 913, 3rd party consultant 906 has access to functionality of messaging server 947, licensing time/billing management server 949, risk analysis server 955 and database server 950, as shown, in server farm 928. Upon reading the teachings of this specification, those with ordinary skill in the art will now understand that, under appropriate circumstances, considering issues such as changes in technology, user requirements, etc., other eCommerce system connectivity for 3rd party consultants, such as, for example, virtual connections from user-interface elements to server farm, and/or security service elements, etc., may suffice.

Further, FIG. 23 shows how risk arbitrator 931, preferably, utilizes IP machine 988 to enable risk arbitrator 931 to connect to access compliant messaging site 913 via communication link 910 and Internet 907 through firewall 958. Preferably, once risk arbitrator 931 connects to compliant messaging site 913, risk arbitrator 931 has access to the functionality of messaging server 947, licensing time/billing management server 949, risk analysis server 955 and database server 950, as shown, in server farm 928. Upon reading the teachings of this specification, those with ordinary skill in the art will now understand that, under appropriate circumstances, considering issues such as changes in technology, user requirements/needs, Internet security measures, eCommerce legislation, etc., other eCommerce system connectivity for risk arbitrator, such as, for example, secure virtual connections to server farm may suffice.

Preferably, the above-stated connectivity also allows risk arbitrator 931 to view supply chain tracking 951, risk tracking 952, and licensing time/billing tracking 953.

Still further, FIG. 23 shows how software developer 903 utilizes IP machine 986 to enable software developer 903 to connect to access compliant messaging site 913 via communication link 985 and Internet 907 through firewall 958. Preferably, once software developer 903 connects to compliant messaging site 913, software developer 903 has access to functionality of messaging server 947, development server 898, licensing time/billing management server 949, supply chain management server 948, risk analysis server 955, and database server 950, as shown, in server farm 928. Upon reading the teachings of this specification, those with ordinary skill in the art will now understand that, under appropriate circumstances, considering issues such as changes in technology, user requirements/needs, Internet security measures, eCommerce legislation, etc., other eCommerce system connectivity for software developers such as, for example, portable wirelessly connected user-interfaces, virtual connections from user-interface elements to back-office billing, settlement, and/or security service elements, etc., may suffice.

Preferably, the above-described connectivity also allows software developer 903 to view supply chain tracking 951, risk tracking 952, and licensing time/billing tracking 953.

Preferably, compliance company 905 utilizes IP machine 960 to compliance company 905 to connect to access compliant messaging site 913 via core router 961 and firewall 958 Internet 907, and link 959. Preferably, once compliance company 905 connects to compliant messaging site 913, compliance company 905 has access to functionality of messaging server 947, licensing time/billing management server 949, supply chain management server 948, risk analysis server 955, and database server 950, as shown, in server farm 928. Upon reading the teachings of this specification, those with ordinary skill in the art will now understand that, under appropriate circumstances, considering issues such as changes in technology, user requirements/needs, Internet security measures, eCommerce legislation, etc., other eCommerce system connectivity for compliance company, such as, for example, secure virtual connections, and/or security service elements, etc., may suffice.

Preferably, the above-stated connectivity also allows compliance company 905 to view supply chain tracking 951, risk tracking 952, and licensing time/billing tracking 953.

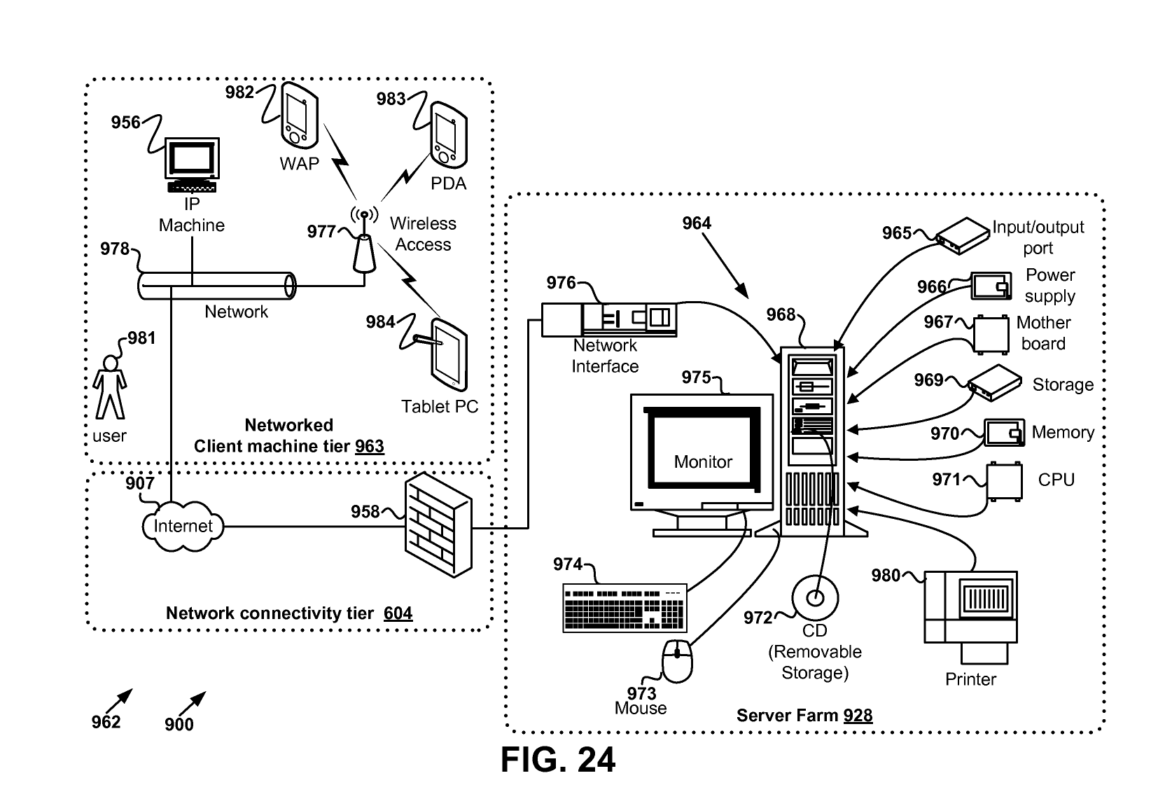

FIG. 24 shows a schematic block diagram view of an exemplary processor configuration for implementation of the business method for compliance management, compliance requirements 914 and risk management 915, according to the preferred embodiment of FIG. 22. Environment 962 comprises server environment 928 and networked user equipment 963, as shown. Additionally, hardware environment 962 comprises at least one server 964, comprising at least one input/output port 965, power supply 966, motherboard 967, chassis 968, storage 969, memory 970 (central processing unit), CPU 971, printer 980, removable storage medium 972, mouse 973, key board 974, monitor 975, network interface 976, wireless network access 977, network 978, firewall 958, and Internet connection 979.

Networked user equipment environment 963 comprises at least one user device IP machine 956, web enabled device (WAP) 982 (personal data assistant), PDA 983, and/or tablet (personal computer) PC 984.

Hardware environment 962 may be used to enable data-flows across a multi-layer architecture of productivity system 900 (see FIG. 23), including the following: at least one client machine tier 991 (represented herein as IP machine 945, IP machine 954, IP machine 956, IP-machine 992, IP Machine 986, and IP machine 960); at least one network connectivity tier 945 (represented herein as Internet 907) with firewall 958 —also, at least one presentation tier (represented herein as compliant messaging site 913, messaging server 947)—also, at least one application (business) tier (represented herein as licensing time/billing management server 949, risk analysis server 955, and supply chain management server 948)—also, at least one database tier (represented herein as database server 950). Upon reading the teachings of this specification, those with ordinary skill in the art will now understand that, under appropriate circumstances, considering issues such as changes in data communications architectures and computing technology, etc., other multi-layered data communications and computing constructs including, such as, for example, interlaced N-tier communications and computing architectures yet to be developed, etc., may suffice.

Chassis 968 of server environment 964, as shown, houses all components that make up server environment 964 and provides at least one input/output port 965. Motherboard 967 of server environment 928 comprises the main logic circuitry and preferably, as shown, provides all necessary circuitry to interconnect all server environment 928 components. Upon reading the teachings of this specification, those with ordinary skill in the art will now understand that, under appropriate circumstances, considering issues such as changes in computer server environment technology, etc., other computer server subassembly and component constructs including elements, such as, for example, highly-integrated motherboards, blade-computer housings yet to be developed, etc., may suffice.

Power supply 966 of server environment 928 may comprise a redundant arrangement of individual power supplies that together preferably provide a fail-safe means of providing necessary power for all hardware environment 962 components, as shown. Power supply 966 minimally may comprise a rating at 150% of maximum use capacity when operating in “hot-standby” mode. Power supply 966 may minimally comprise at least one 300 watt power supply. Upon reading the teachings of this specification, those with ordinary skill in the art will now understand that, under appropriate circumstances, considering issues such as changes in power-inverter technology, etc., other power supply designs including high-frequency inductive and capacitive concepts, such as, for example, switch-mode invertors and converters yet to be developed, etc., may suffice.

Storage 969 of server environment 928 may be configured as a Redundant Array of Independent Drives (RAID). Storage 969 may have “mirroring” (copying of data to more than one physical disk); “striping” (splitting of data across more than one physical disk), and error correction or fault tolerance (redundant storing of data that allows detecting and fixing of data-integrity anomalies). Storage 969 may be, for example, a RAID-5 configuration of at least four-each physical-disc storage sized appropriately for productivity system 900 with at least one serial-attached SCSI 3 Gbps interface. Upon reading the teachings of this specification, those with ordinary skill in the art will now understand that, under appropriate circumstances, considering issues such as changes in electronic data storage technology, etc., other means of dynamically storing electronic data including elements, such as, for example, semiconductor storage means and mango-optical storage means yet to be developed, etc., may suffice.

Memory 970 of server environment 928 may include dynamic RAM (random access memory), semiconductor chips that store system software, programs, and data currently used, as shown, by CPU (central processor unit) 971. Memory 970 may comprise volatile memory, that is, memory contents of which may be lost when/if server environment 928 loses power. Thus, contents of memory 970 should be stored in storage 969 prior to powering down hardware environment 962. Memory 970 may be minimally sized to sustain 150% of the memory requirements of productivity system 900, with fully buffered DIMM (dual inline memory module) memory, as an example. Upon reading the teachings of this specification, those with ordinary skill in the art will now understand that, under appropriate circumstances, considering issues such as changes in semiconductor dynamic memory technology, related semiconductor packaging technology, etc., other semiconductor memory circuits and packaging, such as, for example, bi-polar semiconductor circuits and compatible miniaturized-packaging yet to be developed, etc., may suffice.

CPU (central processing unit) 971 of server environment 928 interprets and executes actual computing tasks of productivity system 900 and has capacity for simultaneously executing multiple processing threads (parallel processing). Upon reading the teachings of this specification, those with ordinary skill in the art will now understand that, under appropriate circumstances, considering issues such as changes in semiconductor processing technology, semiconductor processor packaging technology, etc., other semiconductor processing and related packaging constructs, such as, for example, miniaturized chip design, enhanced clocking, enhanced arrangements for thermal control at faster clock-speeds yet to be developed, etc., may suffice.

Printer 980 of server environment 928 has a standards-based interface with input/output port 965 and is capable of generating reports, as necessary, to communicate information to users of productivity system 900. Upon reading the teachings of this specification, those with ordinary skill in the art will now understand that, under appropriate circumstances, considering issues such as changes in printing technology, print-media technology, etc., other printing and information conveying systems, such as, for example, non-impact carbon deposition technologies, low-environmental impact temporary media yet to be developed, etc., may suffice.

Removable storage media 972 of preferred server environment 928 protects productivity system 900 data from accidental loss, as shown, if hardware environment 962 hardware or storage media fails. Removable storage media 972 establishes at least one backup (e.g., duplicate copies of productivity system 900 data) on archival media, for example, that may be stored on at least one other storage device and retrieved for later use by productivity system 900. Removable storage media 972 comprises minimally, for example, a single 24X IDE CD-ROM drive and CD-ROM discs. Upon reading the teachings of this specification, those with ordinary skill in the art will now understand that, under appropriate circumstances, considering issues such as changes in long-term electronic data storage and data transfer technology, etc., other long-term electronic data storage means, such as, for example, Internet connected disk-arrays, dynamic storage devices, and static storage devices yet to be developed, etc., may suffice.

Mouse 973 (or other pointing device) of preferred server environment 928 has a standards-based interface with input/output port 965 and is capable of conveying signals to CPU 971 via a cursor, as shown, via monitor 975 or equivalent. Mouse 973 minimally comprises, for example, at least one USB 2-button optical mouse, as shown, with at least one scroll function, or equivalent. Upon reading the teachings of this specification, those with ordinary skill in the art will now understand that, under appropriate circumstances, considering issues such as changes in computer pointing-device technology, human-machine interface technology, etc., other computer pointing devices, such as, for example, laser-based pointers or biometric-based pointers yet to be developed, etc., may suffice.

Keyboard 974 of server environment 928 has a standards-based interface preferably with input/output port 965, as shown, and is capable of conveying signals to CPU 971 via at least one keyboard-like interface, as shown. Keyboard 974 allows users, as shown, to enter commands to direct productivity system 900 executions within server environment 928. Keyboard 974 minimally comprises at least one USB keyboard, preferably with at least one hot-key, as shown. Upon reading the teachings of this specification, those with ordinary skill in the art will now understand that, under appropriate circumstances, considering issues such as changes in human-machine interface technology, computer input/output technology, etc., other employee-theft detection system algorithms including elements, such as, for example, optical readers and encoders, biometric readers and encoders yet to be developed, etc., may suffice.

Monitor 975 of server environment 928 comprises displaying at least one input/output text message and at least one graphic symbol, associated with productivity system 900, with sufficient resolution and clarity that user 981 may effectively act in either an administrator role or operator role with productivity system 900. Upon reading the teachings of this specification, those with ordinary skill in the art will now understand that, under appropriate circumstances, considering issues such as changes in computer display technology, etc., other controllable light-emitting display technologies including elements, such as, for example, liquid-crystal-based displays or light-emitting-diode displays yet to be developed, etc., may suffice.

Network interface 976 enables server environment 928 to send at least one communication signal and to receive at least one communication signal from network 978, preferably using at least one standards-based communication-protocol.

Firewall 958, as shown, isolates at least one network from Internet 907, permitting only specific traffic to pass into or out of productivity system 900. Firewall 958 selectively blocks data traffic, typically at ISO/OSI layer 3 and layer 4, and has state knowledge of all data connectivity sessions passing through firewall 958. Firewall 958 typically has: 1) IEEE 802.1x based edge authentication; 2) switch access password protection; 3) at least one user-definable setting for enabling or disabling Web, SSH, Telnet, SSL management access; 4) at least one port-based MAC address alert and lock-down; 5) IP address filtering for management access Layer 2/3/4-based Access Control Lists (ACLs); RADIUS and TACACS+remote authentication; and 6) SSL/SSH encryption. Upon reading the teachings of this specification, those with ordinary skill in the art will now understand that, under appropriate circumstances, considering issues such as changes in data-encryption technology, firewalling technology etc., other data-encryption algorithms and data-network firewalling constructs, such as, for example, multi-layer intrusion detection/prevention, hashing algorithms, and intrusion reporting means yet to be developed, etc., may suffice.

Wireless network access 977 enables networked user equipment environment 963 to send at least one communication signal to at least one other network-enabled device using at least one standards-based communication protocol. Upon reading the teachings of this specification, those with ordinary skill in the art will now understand that, under appropriate circumstances, considering issues such as changes in wireless data-communications technology and/or wireless data-transmission protocols, etc., other wired or wireless data and multi-media communications technologies, such as, for example, laser-based wireless communications technologies, spread-spectrum wireless communications technologies yet to be developed, etc., may suffice.

Internet connection 978 of networked-user-equipment environment 963 has sufficient bandwidth and latency characteristics (data connectivity) such that productivity system 900 may properly execute all functions with all related user devices. Examples of related user devices include WAP enabled mobile phone 982, browser enabled IP machine 956, personal digital assistant (PDA) 983, and tablet PC 984. Internet connection 979 may, for example, comprises a minimum of one-megabit bandwidth (bidirectional) with latency of less then 900 milliseconds. Upon reading the teachings of this specification, those with ordinary skill in the art will now understand that, under appropriate circumstances, considering issues such as changes in networked-user-equipment technology, miniaturized human-machine interaction technology, etc., other networked-user-equipment including human-machine interfaces, such as, for example, integrated networks allowing for multimedia store-and-forward and real-time communications via touch-sensitive input/output interface, biometrics yet to be developed, etc., may suffice.

Although applicant has described applicant's preferred embodiments of this invention, it will be understood that the broadest scope of this invention includes modifications. Such scope is limited only by the below claims as read in connection with the above specification. Further, many other advantages of applicant's invention will be apparent to those skilled in the art from the above descriptions and the below claims.

What is claimed is:

1) A computer system, relating to using at least one GUI display and at least one point/select/command device to transfer useful information, associated with user-selected data associated with at least one data icon, between at least one first software application displaying in at least one first pane and at least one second software application displaying in at least one second pane, comprising:
a) first software application computing means for providing at least one first set of software operations displayable in the at least one first pane;
b) second software application computing means for providing at least one second set of software operations displayable in the at least one second pane;
c) icon selector computing means for selecting, using the point/select/command device, within the at least one first display pane, the at least one data icon;
d) icon mover computing means for moving, using the point/select/command device, the at least one data icon from the at least one first display pane to the at least one second display pane; and
e) icon releaser computing means for releasing, using the point/select/command device, within the at least one second display pane, the at least one data icon;
f) wherein said icon releaser computing means comprises information classifier computing means for classifying the useful information to categorize any metadata to provide metadata classification information; and
g) information transfer computing means for transferring the useful information and any associated metadata classification information to the second software application.

2) The system according to claim 1 wherein said first software application computing means comprises at least one email-client software application.

3) The system according to claim 2 wherein said second software application computing means comprises at least one web-browser software application.

4) The system according to claim 3 wherein said at least one web-browser software application displays within the at least one pane of the at least one email-client software application.

5) The system according to claim 3 wherein:
a) said at least one web-browser software application comprises at least one database client software application; and
b) said information transfer computing means transfers the useful information and such any associated at least one metadata classification information to such at least one database client software application.

6) The system according to claim 5 wherein such any associated at least one metadata classification information comprises at least one user-selected data extension file type.

7) The system according to claim 1 wherein said information classifier computing means comprises file type identifier computing means for identifying at least one user-selected data extension file type.

8) The system according to claim 5, further comprising user limiter computing means for administratively limiting user access to said at least one web-browser software application.

9) The system according to claim 8, wherein said user limiter computing means comprises text field limiter computing means for limiting at least one edit property of at least one editable text field.

10) A computer system, relating to using at least one GUI display and at least one point/select/command device to transfer information, associated with user-selected data associated with at least one data icon, between at least one first software application displaying in at least one first pane and at least one second software application displaying in at least one second pane, comprising:
a) at least one first software application processor structured and arranged to provide at least one first set of software operations displayable in the at least one first pane;
b) at least one second software application processor structured and arranged to provide at least one second set of software operations displayable in the at least one second pane;
c) at least one icon selector processor structured and arranged to select, using the point/select/command device, within the at least one first display pane, the at least one data icon;
d) at least one icon mover processor structured and arranged to move, using the point/select/command device, the at least one data icon from the at least one first display pane to the at least one second display pane; and
e) at least one icon releaser processor structured and arranged to release, using the point/select/command device, within the at least one second display pane, the at least one data icon;
f) wherein said at least one icon releaser processor comprises at least one information classifier processor structured and arranged to classify the information to categorize any metadata; and
g) at least one information transfer processor structured and arranged to transfer the information and any associated at least one user-selected data extension file type to the at least one second software application processor.

11) The computer system according to claim 10 wherein said first software application processor comprises at least one email-client software application processor.

12) The computer system according to claim 11 wherein said second software application processor comprises at least one web-browser software application processor.

13) The computer system according to claim 12 wherein said at least one web-browser software application processor displays within the at least one pane of the at least one email-client software application processor.

14) The computer system according to claim 13 wherein:
a) said at least one web-browser software application processor comprises at least one database client software application processor; and
b) said information transfer processor transfers the useful information and such any associated at least one metadata classification information to such at least one database client software application processor.

15) The computer system according to claim 14 wherein such any associated at least one metadata classification information comprises at least one user-selected data extension file type.

16) The computer system according to claim 10 wherein said information classifier processor comprises at least one file type identifier processor that identifies at least one user-selected data extension file type.

17) The computer system according to claim 14, further comprising at least one user limiter processor that administratively limits user access to said at least one web-browser software application.

18) The computer system according to claim 17, wherein said user limiter processor comprises text field limiter processor that limits at least one edit property of at least one editable text field.

19) A digital storage medium containing computer readable indicia representing a computer program relating to, using at least one GUI display and at least one point/select/command device, transferring information, associated with user-selected data associated with at least one data icon, between at least one first software application displaying in at least one first pane and at least one second software application displaying in at least one second pane, such program comprising the steps of:
a) providing at least one first set of software operations displayable in the at least one first pane;
b) providing at least one second set of software operations displayable in the at least one second pane;
c) selecting, using the point/select/command device, within the at least one first display pane, the at least one data icon;
d) moving, using the point/select/command device, the at least one data icon from the at least one first display pane to the at least one second display pane;
e) releasing, using the point/select/command device, within the at least one second display pane, the at least one data icon;
f) classifying the information to categorize any metadata;
g) identifying at least one user-selected data extension file type;
h) transferring the information and any associated at least one user-selected data extension file type to the at least one second software application.

20) The digital storage medium according to claim 19 wherein said first set of software operations comprises at least one email-client software application.

21) The system according to claim 29 wherein said second set of software operations comprises at least one web-browser software application.

22) The digital storage medium according to claim 21 wherein said at least one web-browser software application displays within the at least one pane of the at least one email-client software application.

23) The digital storage medium according to claim 21 wherein:
a) said at least one web-browser software application comprises at least one database client software application; and
b) the useful information and such any associated at least one metadata classification information is transferred to such at least one database client software application.

24) The digital storage medium according to claim 23 wherein such at least one metadata classification information comprises at least one user-selected data extension file type.

25) The digital storage medium according to claim 21 wherein said classifying the useful information comprises identifying at least one user-selected data extension file type.

26) The digital storage medium according to claim 23 further comprising administratively limiting user access to said at least one web-browser software application.

27) The digital storage medium according to claim 26 wherein said administratively limiting user access comprises limiting at least one edit property of at least one editable text field.

28) A method, relating to providing labor-saving multiple data transfers into at least one database application from another application, comprising the steps of:
a) providing at least one data transfer software application adapted to assist labor-saving information transfer into at least one database application; and
b) monetizing use of such at least one data transfer software application by at least one user seeking such labor-saving information transfer;
c) wherein such at least one data transfer software application comprises at least the steps of
i) providing at least one first set of software operations displayable in at least one first pane of at least one GUI,
ii) providing at least one second set of software operations displayable in at least one second pane of the at least one GUI,
(1) wherein such at least one second set of software operations comprises the at least one database application,
iii) selecting, using at least one point/select/command device, within the at least one first display pane, at least one data icon,
iv) moving, using the at least one point/select/command device, the at least one data icon from the at least one first display pane to the at least one second display pane,
(1) wherein such moving step is enabled to permit at least one user to perform such moving step with exactly one continuous motion of the at least one point/select/command device (“drag”),
v) releasing, using the point/select/command device, within the at least one second display pane, the at least one data icon,
vi) classifying the useful information to categorize any metadata to provide metadata classification information, and
vii) transferring the useful information and any associated metadata classification information to the at least one database application;
d) wherein the at least one user is enabled to make labor-saving multiple data transfers into the at least one database application.

29) The method according to claim 28 wherein such at least one first set of software operations comprises at least one email software application.

30) The method according to claim 29 wherein said at least one second pane comprises at least one browser interface.

31) The method according to claim 30 further comprising the step(s) of:
a) providing, in such at least one database application, sufficient administrative control of such at least one user to enhance labor-saving monetizing of such multiple data transfers;
b) wherein such labor-saving monetizing comprises enabling better performance.

32) The method according to claim 31 wherein such labor-saving monetizing comprises better performing of compliance.

33) The method according to claim 32 wherein such labor-saving monetizing comprises better performing of compliance in at least the area of risk management.

34) The method according to claim 32 wherein such labor-saving monetizing comprises better performing of compliance in at least the area of time management.
